(19) United States
(12) Patent Application Publication
(10) Pub. No.: US 2017/0270965 A1
(43) Pub. Date: Sep. 21, 2017

(54) METHOD AND DEVICE FOR ACCELERATED PLAYBACK, TRANSMISSION AND STORAGE OF MEDIA FILES

(71) Applicant: Samsung Electronics Co., Ltd., Gyeonggi-do (KR)

(72) Inventors: Fei BAO, Beijing (CN); Xianliang WANG, Beijing (CN); Xuan ZHU, Beijing (CN)

(73) Assignee: Samsung Electronics Co., Ltd.

(21) Appl. No.: 15/459,518

(22) Filed: Mar. 15, 2017

(30) Foreign Application Priority Data
Mar. 15, 2016 (CN) 201610147563.2

(51) Int. Cl. G11B 27/00; G10L 15/06; G10L 25/57; G06K 9/00; G11B 27/19

(52) U.S. Cl. CPC G11B 27/005; G06K 9/00744; G11B 27/19; G10L 25/57; G10L 15/063

(57) ABSTRACT

A method and device are provided for accelerated playback, transmission, and storage of a media file. The method includes acquiring key content in text content of a media file to be played acceleratedly; determining a media file corresponding to the key content; and playing the determined media file.

### PRIORITY

This application claims priority under 35 U.S.C. §119(a) to Chinese Patent Application No. 201610147563.2, which was filed in the Slate Intellectual Property Office of the P.R.C. on Mar. 15, 2016, the entire disclosure of which is incorporated herein by reference.

### BACKGROUND

1. Field of the Disclosure

The present disclosure relates generally to media playback and transmission, and in particular, to a method and device for accelerated playback, transmission and storage of a media file.

2. Description of the Related Art

Due to the sustainable development of information technology and the rapid growth of intelligent devices, people are accepting information in various ways. For content presented in various media forms such as audio, video, text, and images, people should quickly determine whether particular content is of interest and then quickly search for and reproduce some key content according to personal preference. Accelerated playback technology can effectively help people to realize this purpose.

Currently, accelerated playback of a video can be realized, for example, at an acceleration rate of 2× or 4×, by playing more images per unit time. Alternatively, each image of a video may be played in a reverse order, a part of the content may ignored according to a fixed period of time or a fixed number of frames, a preview image of key content may be displayed while playing a video, e.g., as illustrated in FIG. 1, or after a position of a key part of the video content is marked, a text outline of the content may viewed by mouse hovering or in other ways, and then the quick positioning is realized by clicking or other operations, e.g., as illustrated in FIG. 2.

However, audio corresponding to a picture often cannot be synchronously played and some important content or plots in a video can be ignored when the video is accelerated playback in these conventional ways.

Further, the rapid development of intelligent wearable devices allows the space and time for people to utilize intelligent devices to be extended greatly. For example, audio media service content can be listened to in various scenarios such as walking, driving, or even doing exercise, since it occupies no human vision.

Currently, accelerated playback of audio is mainly realized by compressing the playback time. For example, the playback at an acceleration rate of 2× or 4× or at other acceleration rates is realized by playing more audio data per unit time, or by identifying speech, blank space, music, or noise and then playing only audio of a particular property.

However, for the current accelerated playback of an audio, after exceeding a certain acceleration rate, it is very likely that a user will be unable to identify the semantic content of the accelerated playback audio, and thus, will be unable to acquire the key content of the audio. Further, reverse playback of audio can usually provide information about a playback progress only according to the timeline, but cannot indicate the real-time content presentation like video playback, which is inconvenient for users to perform accurate browsing and positioning in the audio.

### SUMMARY OF THE DISCLOSURE

The present disclosure is designed to address at least the problems and/or disadvantages described above and to provide at least the advantages described below.

Accordingly, an aspect of the present disclosure is to provide a method and system for accelerated playback, transmission and storage of a media file.

Another aspect of the present disclosure is to provide a method for accelerated playback of a media file, wherein key content in the media file is reserved during the accelerated playback of the media file, so that the integrity of media information is ensured.

In accordance with an aspect of the present invention, a method is provided for accelerated playback of a media file. The method includes acquiring key content in text content of a media file to be played acceleratedly; determining a media file corresponding to the key content; and playing the determined media file.

In accordance with another aspect of the present invention, a method is provided for transmitting and storing a media file. The method includes acquiring key content in text content of a media file to be transmitted or stored, if a preset compression condition is met; determining a media file corresponding to the key content; and transmitting or storing the determined media file.

In accordance with another aspect of the present invention, a device is provided for accelerated playback of a media file. The device includes a key content acquisition module configured to acquire key content in text content in a media file to be played acceleratedly; a media file determination module configured to determine a media file corresponding to the key content; and a media file playback module configured to play the determined media file.

In accordance with another aspect of the present invention, a device is provided for transmitting and storing a media file. The device includes a key content acquisition module configured to acquire key content in text content of a media file to be transmitted or stored, if a preset compression condition is met; a media file determination module configured to determine a media file corresponding to the key content; and a transmission or storage module configured to transmit or store the determined media file.

### BRIEF DESCRIPTION OF DRAWINGS

The above and other aspects, features, and advantages of certain embodiments of the present disclosure will be more apparent from the following detailed description taken in conjunction with the accompanying drawings, in which:

FIG. 1 illustrates a conventional preview and quick positioning method using a displayed preview image;

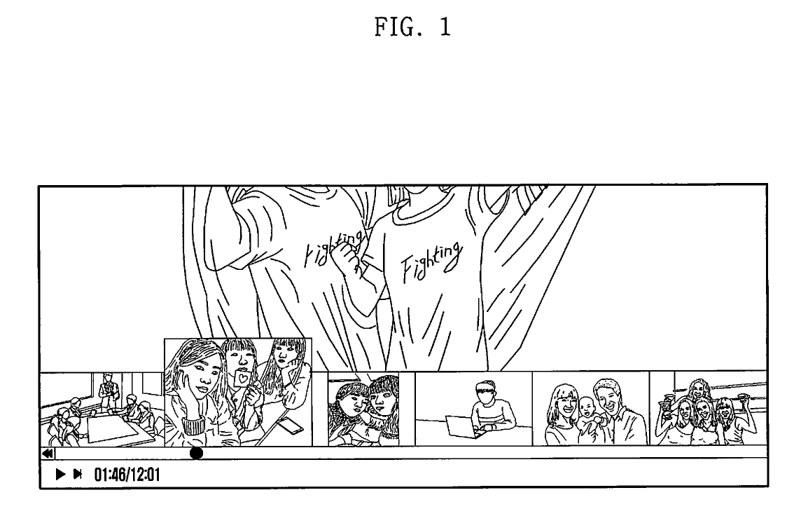

FIG. 2 illustrates a conventional preview and positioning method using marked positions of key parts of video content;

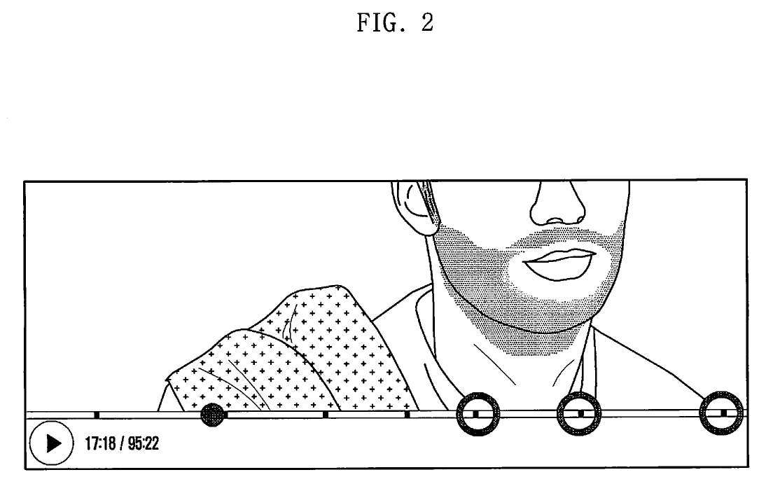

FIG. 3 illustrates selection of an accelerated playback mode in an audio/video playback interface according to an embodiment of the present disclosure;

FIG. 4 is a flowchart illustrating a method for accelerated playback of a media file according to an embodiment of the present disclosure;

FIG. 5 illustrates accelerated playback of an audio file according to an embodiment of the present disclosure;

FIG. 6 illustrates phonemes corresponding to audio frames in audio content according to an embodiment of the present disclosure;

FIG. 7 illustrates speech enhancement through a speech synthesis model according to an embodiment of the present disclosure;

FIG. 8 illustrates fragments having speech amplitude and speed that do not correspond with an average level, according to an embodiment of the present disclosure;

FIG. 9 illustrates fragments that are subject to amplitude and speed normalization of speech, according to an embodiment of the present disclosure;

FIG. 10 illustrates a display of simplified text content using a screen in a side screen portion according to an embodiment of the present disclosure;

FIG. 11 is a schematic diagram of displaying simplified text content by using a screen in a peripheral portion of a watch according to an embodiment of the present disclosure;

FIG. 12 illustrates a method for compressing and storing a media file according to an embodiment of the present disclosure;

FIG. 13 illustrates a device for accelerated playback of a media file according to an embodiment of the present disclosure; and

FIG. 14 illustrates a device for compressing and storing a media file according to an embodiment of the present disclosure.

### DETAILED DESCRIPTION OF EMBODIMENTS OF THE DISCLOSURE

Hereinafter, various embodiments of the present disclosure will be described with reference to the accompanying drawings. The embodiments and the terms used herein are not intended to limit the disclosed technology to specific forms, and the present disclosure should be understood to include various modifications, equivalents, and/or alternatives to the corresponding embodiments. In describing the drawings, similar reference numerals may be used to designate similar constituent elements.

Herein, terms such as “module” and “system” are intended to include entities related to computers, for example, but are not limited to hardware, firmware, software, a combination of software and hardware, or software under execution. For example, the module may be a process running on a processor, a processor, an object, an executable program, an executed thread, a program and/or a computer. Both an application running on a computing device and the computing device may be a module. One or more modules may be located in a process and/or thread under execution, and one module may also be located on one computer and/or distributed over two or more computers.

In practical accelerated video playback applications, the accelerated playback of audio often will result in audio distortion due to time compression, so that the audio corresponding to the video picture cannot be synchronously played. Further, determining video content that a user is interested in is often based on the image content of a preview image. When there is an occasion (chat, interview, etc.) with a large amount of dialogue, information in this occasion cannot be reserved, so to the user often ignores important content or plots in the video.

Further, video images contain information which can be independently identified by human eyes, so the content in the original video can be stringed and then restored by acquiring information in each image, even if the video images are played in a reverse order. However, the understanding of the speech content by human ears is realized on the basis of understanding audio fragments in units of words. Accordingly, if audio is played in a reverse order, human ears are likely unable to acquire any semantic information. Therefore, the reverse playback of audio usually provides information about playback progress only according to the timeline, but cannot be used for real-time content presentation like video playback.

Additionally, the accelerated playback of audio often results in audio distortion due to time compression. For example, after exceeding an acceleration rate of 2×, an ordinary person is unable to acquire semantic content of the played speech. Therefore, if the user is required to acquire semantic content from audio, an acceleration rate of 2× basically becomes an upper limit of accelerated playback of the audio.

As described above, both the accelerated playback of audio and the accelerated playback of video involve a compression process of audio, but the existing methods of accelerated playback of audio, which are performed by compressing the playback time, cannot ensure the integrity of information and are inconvenient for positioning the semantic content in the audio.

Therefore, in order to conveniently identify key information, and thus, ensure the integrity of information, in accordance with an embodiment of the present disclosure, it is possible to acquire text content of a media file, such as an audio file or a video file, then simplify the text content of the media file to acquire key content in the text content of the media file, determine a media file corresponding to the acquired key content, and then play or transmit the determined media file. As the key content is reduced with respect to the original text content, the media file corresponding to the key content is reduced with respect to the content of the original media file, so that the accelerated playback of the media file can be realized. In comparison with the conventional accelerated playback of a media file by compressing the playback time, by simplifying text content of a media file, the present disclosure reserves the key content of the original text content and ensures the integrity of information, so that a user may easily acquire key information in the media file, even if the playback speed is very fast.

When a user views or listens to a media file, they user may want to perform accelerated playback of the media file. For example, if a user wants to directly select a program of interest from numerous audio/video programs, the user should have a general idea of the content and style of every audio/video program by means of quick browsing. In this case, the accelerated playback is an effective way to help the user to realize this purpose. When a user begins to listen to a certain audio program and finds that the user has already listened to this part of this program, but cannot remember the specific position where the user stopped listening, the accelerated playback can help the user to quickly find the previous position where listening stopped. When a user searches for certain message from numerous voice messages or messages, but cannot give a specific keyword or content for searching, the accelerated playback can also help the user quickly search for the content (message) of interest. Further, when a user is distracted or answers a call while driving or doing exercise and then determines that the audio has been playing for a while when listening to the audio resumed, if the user wants to return to the previous position, the accelerated playback in a reverse order can help the user to quickly find this position.

At present, the key content in text content in a media file to be played acceleratedly can be acquired in advance by offline processing; and after a media file corresponding to the key content is determined, when a user desires accelerated playback (for example, when an accelerated playback instruction of a user is detected), the determined media file is played.

Alternatively, when a user desires accelerated playback, the key content in text content of a media file to be played acceleratedly can be acquired by online processing; and then, a media file corresponding to the key content is determined and the determined media file is played.

The accelerated playback function of a media file can be activated by activating the accelerated playback instruction. Therefore, before the accelerated playback of a media file, the accelerated playback instruction may be detected.

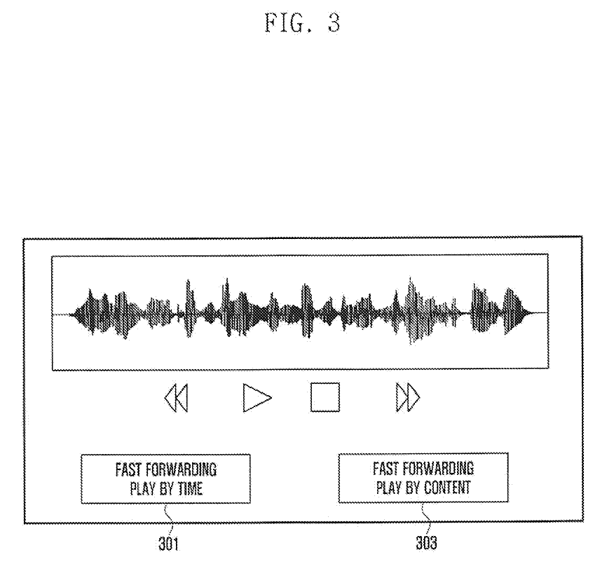

FIG. 3 illustrates selection of an accelerated playback mode in an audio/video playback interface according to an embodiment of the present disclosure.

Referring to FIG. 3, when a user is playing an audio/a video or before the user plays the audio/video, if the user presses a button (or icon) “FAST FORWARDING PLAY BY TIME” 301 in the audio/video playback interface, the playback time duration of the audio/video file can be compressed in an existing accelerated playback manner. However, if the user presses a button (or icon) “FAST FORWARDING PLAY BY CONTENT” 303 in the audio/video playback interface, an accelerated playback in accordance with an embodiment of the present disclosure is activated. Alternatively, the audio/video playback interface may only include the button “FAST FORWARDING PLAY BY CONTENT” 303.

In accordance with an embodiment of the present disclosure, if a user triggers the accelerated playback function when an audio file having a time duration of 20 min is played to 10 min, the accelerated playback can be initiated from the ten minute mark.

For example, a user can activate the accelerated playback instruction by speech, a gesture, a key, an external controller, etc.

When the accelerated playback instruction of a media file is activated by speech, a preset voice-controlled instruction, for example, “ACCELERATED PLAYBACK”, may be used. Thus, if the voice-controlled instruction “ACCELERATED PLAYBACK” is received by a device, speech recognition will be performed on the voice-controlled instruction, and the device may determine that the accelerated playback instruction has been received.

When the accelerated playback instruction of a media file is activated by a key, e.g., a hardware key or a virtual key. Thus, a user can long-press a hardware key, such as Volume or Home, to activate the accelerated playback function, or the user may activate the accelerated playback using a virtual key, such as a virtual control button, a menu, etc. on a screen, e.g., as illustrated in FIG. 3.

The accelerated playback instruction of a media file may be activated by a gesture, for example, double-clicking a screen/long-pressing a screen, shaking/rolling/tilting a terminal, or long-pressing the screen and shaking the terminal.

Where the accelerated playback operation function of a media file is activated by an external controller, the external controller can be a stylus associated with a terminal. For example, when the stylus is pulled out and then quickly inserted into the terminal, when a preset key on the stylus is pressed down, or when a preset air gesture is performed by a user by using the stylus, the terminal may identify that the accelerated playback instruction has been received. The external controller may also be a wearable device or other device associated with the terminal. The wearable device or other device associated with the terminal can confirm that a user wants to activate the accelerated playback function by at least one of an interactive mode of speech, key, and gesture therein, and then inform the terminal thereof.

For example, the wearable device can be a smart watch, a pair of smart glasses, etc. The wearable device or other device associated with the terminal can access to the terminal of the user by WI-FI, near field communication (NFC), Bluetooth, and/or a data network.

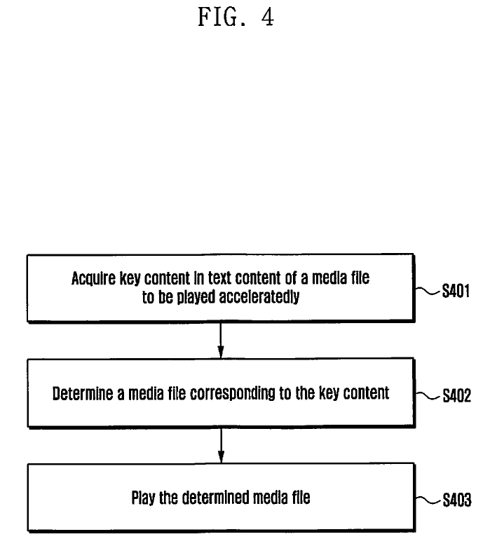

FIG. 4 is a flowchart illustrating a method for accelerated playback of a media file according to an embodiment of the present disclosure.

Referring to FIG. 4, in step S401, key content is acquired among text content of a media file to be played acceleratedly.

For example, before a terminal offline processes a media file to be played acceleratedly, or online processes a media file to be played acceleratedly after receiving the accelerated playback instruction activated by a user, an acceleration rate and an acceleration direction of the accelerated playback may be determined. Thereafter, a media to be played acceleratedly can be determined from the currently played media file according to the determined acceleration rate and acceleration direction.

The acceleration rate and acceleration direction of the accelerated playback can be indicated by an accelerated playback instruction or designated in advance by a user. When a user activates the accelerated playback instruction, the acceleration rate indicated by the accelerated playback instruction can be a preset acceleration rate, e.g., a default acceleration rate of 2×. Thus, when a user does not specifically designate the acceleration rate, the accelerated playback can be performed at the default acceleration rate.

When a user activates an accelerated playback instruction to indicate the accelerated playback of a media file, an acceleration rate can be simultaneously indicated. For example, virtual rate keys corresponding to different acceleration rates may be presented in an audio playback interface, and a user can select a certain virtual rate key to perform the accelerated playback of the audio. Thereafter, the accelerated playback is performed at an acceleration rate corresponding to the selected virtual rate key.

When a user activates an accelerated playback instruction, the acceleration direction indicated by the accelerated playback instruction may be a preset acceleration direction, e.g., acceleration in a forward direction by default. Thus, when the user does not specifically designate the acceleration direction, the accelerated playback can be performed in the default direction.

When a user activates an accelerated playback instruction to indicate the accelerated playback of audio, an accelerated playback direction can be simultaneously indicated, i.e., the acceleration direction may be designated by the user. For example, virtual direction keys corresponding to different accelerated playback directions (forward direction and reverse direction) may be presented in an audio playback interface, and a user may select a certain virtual direction key to perform the accelerated playback of the audio. Thereafter, the accelerated playback may be performed at a preset acceleration rate and in the direction corresponding to the selected virtual direction key.

Alternatively, after the terminal detects the user selection of a virtual direction key, virtual rate keys corresponding to different acceleration rates may be displayed in the interface and the user may then select a certain virtual rate key corresponding to a desired acceleration rate. Thereafter, the accelerated playback is performed at the acceleration rate corresponding to the selected virtual rate key and in the direction corresponding to the selected virtual direction key.

After the accelerated playback instruction activated by the user is received, a media file to be played acceleratedly can be determined according to the acceleration rate and/or acceleration direction indicated by the accelerated playback instruction. Thereafter, for the media file to be played acceleratedly, the text content of the media file to be played acceleratedly is acquired. For example, if the acceleration direction is different, the medial file to be played acceleratedly will be different. If the time duration of the audio currently played by the terminal is T and the user selects a virtual key FORWARD when the playback progress is t, the media file from the playback progress t to T is a media file to be played acceleratedly. If the user clicks a virtual key REWIND, the media file from the playback progress 0 to t is a media file to be played acceleratedly.

The media file to be played acceleratedly may be collected by the terminal or pre-stored or acquired from a network side. The media file acquired from the network side may include a media file that is downloaded from the network side to a local storage, and/or a media file that is online browsed at the network side.

For example, an audio file to be played acceleratedly may include audio recorded by the terminal using a sound collection equipment; online broadcasting (e.g., a talk show, a broadcasting program, etc.); an education course audio; an audiobook; audio from voice communication; audio of a telephone conference or a video conference; audio included in a video; audio generated by electronic text speech synthesis; audio in a voice notification; audio in a voice message; an audio in a voice memo; etc.

For example, the terminal may be an mp3 player, a smart phone, intelligent wearable device, etc.

After the media file to be played acceleratedly is determined, text content of the media file to be played acceleratedly may be acquired. The acquired text content may include content units and temporal position information, and each of the content units may have corresponding temporal position information, respectively.

When the media file is an electronic text, the text content of the electronic text to be played acceleratedly is directly regarded as the text content of the media file to be played acceleratedly. However, when the media file is an audio file or a video file, the text content corresponding to the audio content in the audio file or video file may be regarded as the text content of the media file to be played acceleratedly. The text content corresponding to the audio content in the audio file or video file may be predetermined (e.g., song lyrics or video closed captioning) or may obtained by the speech recognition technology.

Based on the speech recognition technology, through a preset speech recognition engine, the corresponding text content can be recognized from the audio content of the media file to be played acceleratedly. During recognition of the audio content, the respective temporal position information of each of content units of the recognized text content can be recorded.

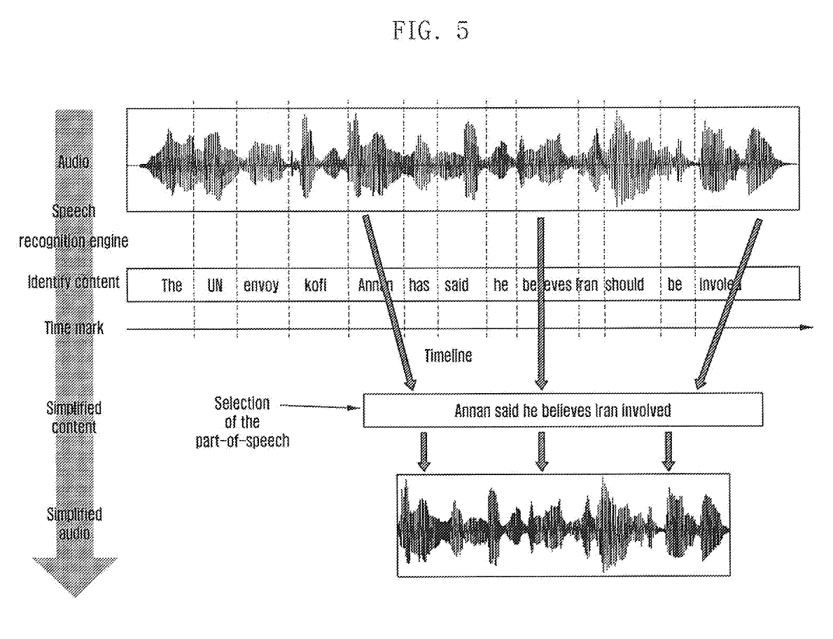

FIG. 5 illustrates accelerated playback of an audio file according to an embodiment of the present disclosure.

Referring to FIG. 5, audio may be recognized by a speech recognition engine, wherein temporal position information of each of the content units in the recognized content is marked on a timeline, and the simplified content may be selected according to a part-of-speech of the content units. The simplified audio corresponding to the simplified content may then be determined.

The granularity of partition of the content units may be preset by the system or selected by a user. For example, the granularity of partition of the content units in the text content may be determined according to the acceleration rate corresponding to the media file to be played acceleratedly, and then the content units of the text content are partitioned according to the determined granularity of partition. The partitioned content units may be syllables, characters, words, sentences, or paragraphs. Thus, based on the speech recognition technology, text content in the audio/video file may be obtained, and temporal position information corresponding to each character or even each syllable of this character may also be obtained.

To prevent from ignoring important content or plots in a media file and to ensure the integrity of information, the key content in the text content of the media file may be acquired by using different content simplification strategies, in order to realize the simplification of the media file.

For example, a part-of-speech of the text content, an information amount, an audio speech speed, an audio volume, content of interest, a media file type, information about content source objects, and/or other information can often reflect the criticality of each part of content in the media file. Therefore, different content simplification strategies may be selected according to the part-of-speech of the content units in the text content, the information amount of the content units, the audio volume of the content units, the audio speech speed of the content units, the content of interest in the text content, the media file type, the information about content source objects, the acceleration rate, the media file quality, the playback environment, etc.

Referring again to FIG. 3, after the text content of the media file to be played acceleratedly is determined, the key content in the text content of the media file to be played acceleratedly may be acquired according to the part-of-speech of content units in the text content, the information amount of the content units, the audio volume of the content units, the audio speech speed of the content units, the content of interest in the text content, the media file type, the information about content source objects, the acceleration rate, the media file quality, the playback environment, etc.

In step S402, a media file is determined, which corresponds to the key content in the text content of the media file to be played acceleratedly.

When the media file is an electronic text file, the determined key content can be directly regarded as a media file corresponding to the key content; and when the media file is an audio file or a video file, a media file corresponding to the key content in the text content of the medial file to be played acceleratedly can be determined according to the temporal position information corresponding to each content unit in the key content.

The media file corresponding to the key content in the text content of the media file to be played acceleratedly may also be referred to as “a simplified media file”.

After the key content (i.e., the simplified content) in the text content of the medial file to be played acceleratedly is acquired, the temporal position information corresponding to each content unit in the simplified content may be determined. Subsequently, corresponding media file fragments are extracted according to the temporal position information, and then the media file fragments are combined to generate a corresponding media file. For example, audio fragments corresponding to the key content may be extracted from the audio content of the media file to be played acceleratedly according to the determined temporal position information, and the extracted audio fragments are merged to generate an audio file corresponding to the simplified content.

The terminal may merge media file fragments corresponding to the key content according to the acceleration direction of the accelerated playback, and then combine the media file fragments to generate a media file corresponding to the key content.

For example, when the acceleration direction of the accelerated playback is a forward direction, the media file fragments corresponding to the key content are merged in the forward direction and then combined to generate a media file corresponding to the key content; and when the acceleration direction of the accelerated playback is a reverse direction, the media file fragments corresponding to the key content are merged in the reverse direction and then combined to generate a media file corresponding to the key content.

In step S403, the determined media file is played.

A user can trigger the accelerated playback function before or during playing the media file.

When a user triggers the accelerated playback function before playing the media file, the terminal may acquire key content in all text content of the media file to be played acceleratedly, after detecting the user's accelerated playback instruction, then obtain a media file corresponding to the key content according to the acquired key content, and play the determined media file.

Without playing while processing, this may improve the real-time effect of the accelerated playback.

In addition, when a user triggers the accelerated playback function before playing a media file, the terminal may successively intercept media file fragments from the media file to be played acceleratedly in chronological order, after the user's accelerated playback instruction is detected, then acquire key content in the text content of each of the intercepted media file fragments, determine a media file corresponding to the key content in the text content of each of the media file fragments, and play the determined media file. Thus, while playing the media file corresponding to the key content in the text content of the current media file fragment, the terminal may simultaneously perform the above processing on the next media file fragment, e.g., until the user's accelerated playback end instruction is detected or the processing to all media file fragments is completed. Accordingly, the terminal may process while playing, without pre-processing all the content in advance, thereby shortening the time for responding the accelerated playback function.

The terminal may extract media file fragments at default time intervals, or may set the time intervals according to the length of the media file. In addition, the terminal may recognize all text content of the media file first and then acquire the text content of the currently processed media file fragment according to the temporal position information corresponding to the media file fragment, or the terminal may recognize text content in real time with respect to the currently processed media file fragment.

When a user triggers the accelerated playback function while playing the media file fragments, the terminal may acquire all the text content corresponding to the media file to be played acceleratedly according to the acceleration direction of accelerated playback, after the user's accelerated playback instructions are detected. Thereafter, key content is acquired from the all text content, and a media file corresponding to the acquired key content is played. For example, if the time duration of the audio is 20 min, and the user triggers the accelerated playback function in a forward direction while the audio is played at the 10 min mark, the terminal acquires all the text content from 10 min to 20 min. However, when the playback direction of accelerated playback is a reverse direction, the terminal acquires all the text content from 0 min to 10 min. Without playing while processing, this may improve the real-time effect of accelerated playback.

When a user triggers the accelerated playback function while playing the media file, the terminal may successively intercept media file fragments from the current playback time point according to the playback direction and time sequence of the accelerated playback, after the user's accelerated playback instruction is detected, and then determine the text content of each of the intercepted media file fragments. From the key content in the text content of the current media file fragment, the media file corresponding to the key content corresponding to the media file fragment is played. While the media file corresponding to the key content corresponding to the current media file fragment is played, the terminal may simultaneously perform the above-described processing on the next media file fragment, e.g., until the user's accelerated playback end instruction is detected or the processing to all media file fragments is completed. Accordingly, the terminal may perform processing while playing, without pre-processing all the content in advance, thereby shortening the time for responding the accelerated playback function.

The terminal may also store the media file to be played acceleratedly, the text content of the media file to be played acceleratedly, the key content in the text content, the media file corresponding to the key content, etc. Thus, during the subsequent accelerated playback, the above stored information can be retrieved, so that the response speed and processing efficiency of accelerated playback are improved.

After the media file corresponding to the key content is determined, the playback strategy of the media file corresponding to the key content may be adjusted according to the environment noise intensity of the ambient environment of the media file, audio quality, audio speech speed, audio volume, acceleration rate, and/or other factors.

As described above, in accordance with an embodiment of the present disclosure, accelerated playback of a media file to be played may be performed by simplifying text content of the media file to obtain key content, instead of compressing the playback time. The key information of the original media file is reserved in the simplified key content, so that the integrity of information is ensured. Thus, even if the playback speed is very fast, the user can acquire key information of the media file. In addition, during playing the media file corresponding to the key content, the playback speed can be adjusted subsequently by the speech speed estimation and the audio quality estimation of the original media file and in combination with the requirements of the accelerated playback efficiency, in order to ensure that the user can clearly understand the audio content at this playback speed.

By playing the simplified content instead of compressing the playback time, the played content is reduced, so the actual playback speed (efficiency) of the user is improved. For example, by counting a Chinese part-of-speech, the probability of occurrence of both nouns and verbs in the corpus is less than 50%. In accordance with an embodiment of the present disclosure, the user can realize a quick playback and browsing rate of over 2× while maintaining the original speed of the speech. If more content simplification rules are combined and the speed of speech is properly quickened, the quick playback and browsing rate can be improved even more greatly.

I. Acquisition of Key Content According to the Part-of-Speech

When key content is acquired according to the part-of-speech, the granularity of partition of content units can be word.

The acquiring key content in text content in a media file to be played acceleratedly according to the part-of-speech of content units in the text content corresponding to the media file to be played acceleratedly may include determining content units corresponding to the auxiliary part-of-speech not to be the key content,

in text content formed of at least two content units,

determining content units corresponding to the key part-of-speech to be the key content, in the text content formed of at least two content units, determining content units of the designated part-of-speech not to be the key content, and determining content units of the designated part-of-speech to be the key content.

When the content units corresponding to the auxiliary part-of-speech are determined not to be the key content, the content units corresponding to the auxiliary part-of-speech may be deleted. When the content units corresponding to the key part-of-speech are determined to be the key content, the content units corresponding to the key part-of-speech may be reserved as the key content, or the content units corresponding to the key part-of-speech are extracted to serve as the key content. When the content units of the designated part-of-speech are determined not to be the key content, the content units of the designated part-of-speech may be deleted. When the content units of the designated part-of-speech are determined to be the key content, the content units of the designated part-of-speech may be reserved as the key content, or the content units of the designated part-of-speech are extracted to serve as the key content.

The auxiliary part-of-speech includes part-of-speech having at least one of modification, auxiliary description, and determination.

Some nouns and verbs may be reserved, and words of other part-of-speech may be ignored. Therefore, when the key content is acquired according to the part-of-speech, content units of adjectives, conjunctions, prepositions, and other designated part-of-speech may be deleted, and/or the content units of nouns, verbs, and other designated part-of-speech may be reserved as the key content.

For multiple neighboring nouns, the anterior nouns usually play a role in modifying the last noun. Therefore, it is possible to reserve the last noun in a combination of at least two neighboring nouns and/or delete content units, except for the last noun in the combination of at least two neighboring nouns. For example, for a combination of “Political Bureau ( [symbol] , noun) Meeting ( [symbol] , noun)”, “Meeting” is reserved as the key content.

For multiple neighboring verbs, the anterior verbs usually play a role in modifying the last verb, so it is possible to delete content units except for the last verb in a combination of at least two neighboring verbs and/or reserve only the last verb. For example, for “prepare ( [symbol] , verb) research ( [symbol] , verb) deploy ( [symbol] , verb)”, “deploy” is reserved as the key content.

For a “preposition+noun”, “preposition+noun” usually play a modification role and is equivalent to an adjective, so this combination may be omitted, i.e., the combination of “preposition+noun” may be deleted. For example, for “Meeting ( [symbol] , noun) is held ( [symbol] , verb) in ( [symbol] , preposition) Beijing ( [symbol] , noun)”, “Meeting is held” is reserved as the key content.

For a “noun+of+noun”, “noun+of” usually plays a modification role, so “noun+of” may be considered to be omitted, i.e., “noun+of” in the combination “noun+of+noun” may be deleted. For example, for “Tian'anmen ( [symbol] , noun) of ( [symbol] , auxiliary word) Beijing ( [symbol] , noun)”, “Tian'anmen” is reserved as the key content.

For a “noun/verb/adjective+conjunction+noun/verb/adjective+noun/verb”, it is possible to delete “noun/verWadjective+conjunction+noun/verb/adjective” in the combination “noun/verb/adjective+conjunction+noun/verb/adjective+noun/verb” and only reserve the last noun or verb as the key content. For example, for “continuous ( [symbol] , verb) expansion ( [symbol] , verb) of range ( [symbol] , noun) of Beijing ( [symbol] , noun) and ( [symbol] , conjunction) Shanghai ( [symbol] , noun) cities ( [symbol] , noun)”, “expansion of range of cities” is reserved as the key content.

“Auxiliary word+verb” in English, Latin and other languages usually plays a role of auxiliary description, so such a combination may be omitted, i.e., the combination “auxiliary word+verb” may be deleted. For example, for “I have a lot of work to do”, “I have work” is reserved as the key content.

The following shows the content of a piece of news and the part-of-speech corresponding to each word:

Leaders ( [symbol] )|n organized to ( [symbol] )|v hold( [symbol] )|v Political Bureau ( [symbol] )|n meeting ( [symbol] )|n, research ( [symbol] )|v deploy ( [symbol] )|v next year ( [symbol] )|n Party's style ( [symbol] )|n clean government ( [symbol] )|n construction ( [symbol] )|n and ( [symbol] )|c anti-corruption ( [symbol] )|j work ( [symbol] )|n. National ( [symbol] )|n colleges ( [symbol] )|n party building ( [symbol] )|n work ( [symbol] )|n meeting ( [symbol] )|n was held ( [symbol] )|v in ( [symbol] )|p Beijing ( [symbol] )|n, leaders ( [symbol] )|n made ( [symbol] )|v important ( [symbol] )|j instructions ( [symbol] )|n and emphasized that ( [symbol] )|v strengthening ( [symbol] )|v the leadership ( [symbol] )|n of ( [symbol] )|u the Party ( [symbol] )|n is ( [symbol] )|v the fundamental ( [symbol] )|d guarantee ( [symbol] )|v of ( [symbol] )|u running ( [symbol] )|v colleges ( [symbol] )|n with Chinese ( [symbol] )|n characteristics ( [symbol] ).

In the paragraph above, n denotes noun, v denotes verb, j denotes adjective, c denotes conjunction, p denotes preposition, and u denotes auxiliary word.

For this paragraph of text content, the key content is acquired according to the part-of-speech:

“organize ( [symbol] )|v hold ( [symbol] )|v” is a combination of “verb+verb”, so the last verb “hold ( [symbol] )” is reserved;

“Political Bureau ( [symbol] )|n meeting ( [symbol] )|n” is a combination of “noun+noun+noun”, so the last noun “meeting ( [symbol] )” is reversed;

“next year ( [symbol] )|n Party's style ( [symbol] )|n clean government ( [symbol] )|n construction ( [symbol] )|n and ( [symbol] )|c anti-corruption ( [symbol] )|j work ( [symbol] )|n” is a combination of “noun+conjunction+adjective+noun”, so the last noun “work ( [symbol] )” is reserved; and

“in ( [symbol] )|p Beijing ( [symbol] )|n” is a combination of “preposition+noun”, so this combination is omitted.

Thus, the finally obtained key content is as follows: “Leaders held meeting to deploy work ( [symbol] , [symbol] ). Meeting was held, leaders made instructions to strengthen the leadership and run colleges ( [symbol] , [symbol] [symbol] , [symbol] )”.

The quick browsing playback of the user demands to play in a reverse order, and accordingly, it is possible to acquire the simplified content required by the reverse playback operation: “guarantee of running colleges, leaders strengthened instructions, made, leaders held meeting, work deploy, meeting was held, leaders ( [symbol] [symbol] [symbol] [symbol] [symbol] [symbol] )”.

Thus, audio fragments in units of words are obtained subsequently. The reverse playback of the audio fragments in unit of words is advantageous for a user to string and understand the content of the whole audio based on the correct understanding of each word, thereby realizing the reverse playback and quick reverse playback of the audio.

II. Acquisition of Key Content According to the Information Amount

The key content in text content of a media file to be played acceleratedly may also be acquired according to the information amount of content units in the text content corresponding to the media file to be played acceleratedly. When key content is selected as described above, the granularity of partition of the content units may be word.

The information amount of each content unit in text content of a media file to be played acceleratedly may be determined; and then, according to the information amount of any content unit in the text content corresponding to the media file to be played acceleratedly, this content unit is determined to be reserved or deleted.

With respect to each content unit in the text content of the media file to be played acceleratedly, an information amount model library corresponding to the content type of this content unit may be selected; and the information amount of this content unit may be determined by using the information amount model library and the context of this content unit.

Accordingly, it is possible to perform training in advance, based on the whole corpus and lexicon, in order to acquire the information amount included in each word with respect to the corresponding context. Subsequently, different information amount model libraries may be trained with respect to different content types. Thus, in subsequent applications, it is possible to first determine the content type of a content unit and then select a corresponding information amount model library for measuring and deciding the information amount of this content unit.

It is also possible to separately determine to delete or reserve a content unit by using the information amount of this content unit when the key content is acquired. For each content unit, if the information amount of the content unit is not less than a first information amount threshold, the content unit may be reserved as the key content in the text content of the media file; and/or if the information amount of this content unit is not greater than a second information amount threshold, this content unit may be deleted.

Further, it is possible to comprehensively determine to ignore or reserve a content unit by using the information amount of this content unit in combination with the part-of-speech or other factors. For example, for the content determined to be reserved according to the part-of-speech, the information amount of a content unit can be further determined, and the content unit may be deleted when the information amount of the content unit is not greater than the second information amount threshold. However, for the content determined to be deleted according to the part-of-speech, the information amount of a content unit can be further determined, and the content unit may be reserved as the key content in the text content of the media file when the information amount of the content unit is not less than the first information amount threshold.

The text content reserved according to the part-of-speech may be obtained after simplifying the text content of the media file according to the part-of-speech. Thereafter, the information amount of each content unit in the text content reserved according to the part-of-speech is determined, and with respect to each content unit, if the information amount of the content unit is not greater than the second information amount threshold, the content unit may be deleted.

The text content deleted according to the part-of-speech may also be obtained after simplifying the text content of the media file according to the part-of-speech. Thereafter, with respect to each content unit in the text content deleted according to the part-of-speech, the information amount of the content unit is determined; and if the information amount of the content unit is not less than the first information amount threshold, the content unit may be reserved as the key content in the text content of the media file.

III. Acquisition of Key Content According to Audio Volume

In some speech fragments, a speaker will stress some words by increasing the volume for purpose of indicating the importance of these words. Conversely, if the speaker says some words in a lower volume, to some extent, this may indicate that the information expressed by these words is not as important.

However, merely based on the text analysis, the words stressed by the speaker cannot be regarded as the key content, but the words spoken softly by the speaker may be regarded as the key content. Therefore, the information about sound intensity of a speaker may be analyzed and applied in determining the key content of the speech.

The key content in text content of a media file to be played acceleratedly may be acquired according to the audio volume of content units in the text content corresponding to the media file to be played acceleratedly. For example, the granularity of partition of the content units may be a word.

According to an audio volume of a content unit in the text content corresponding to the media file to be played acceleratedly, the content unit may be determined to be reserved or deleted. For example, if the audio volume of the content unit is not less than a first audio volume threshold, the content unit may be reserved as the key content, but if the audio volume of this content unit is not greater than a second audio volume threshold, the content unit is deleted.

The first audio volume threshold and the second audio volume threshold may be determined according to an average audio volume of the media file to be played acceleratedly; an average audio volume of text fragments where content units corresponding to the media file to be played acceleratedly are located; an average audio volume of content source objects corresponding to content units in the text content corresponding to the media file to be played acceleratedly; and/or in the text content corresponding to the media file to be played acceleratedly, an average audio volume of content source objects corresponding to content units in text fragments where the content units are located.

The content source object may be a speaker in the audio/video, a sounding object, or a source corresponding to the text in the electronic text. The first audio volume threshold and the second audio volume threshold may be determined according to average audio volumes and/or first and second preset volume threshold factors.

For example, a first audio volume threshold and a second audio volume threshold may be set with respect to each speaker in the audio to be played acceleratedly. The product of an average audio volume and the set first volume threshold factor may be confirmed as the first audio volume threshold, and the product of the average audio volume and the set second volume threshold factor may be confirmed as the second audio volume threshold.

If the average audio volume is an average volume determined with respect to the whole media file to be played acceleratedly, it is possible to determine whether the audio volume of a content unit in the media file to be played acceleratedly is greater than the average volume and whether the difference between the audio volume and the average volume is not less than the first audio volume threshold. If so, this content unit may be considered as important information and may be reserved as the key content; otherwise, the content unit may be deleted.

If the average audio volume is an average volume determined with respect to the text fragments where the content units in the text content of the media file to be played acceleratedly are located, it is possible to determine whether the volume of a content unit in the media file to be played acceleratedly is greater than the average volume of the text fragment and whether the difference between the volume and the average volume is not less than the first audio volume threshold. If so, the content unit may be considered as important information and may be reserved as the key content; otherwise, the content unit may deleted.

If the average audio volume is an average volume determined with respect to, in the text content corresponding to the media file to be played acceleratedly, a content source object corresponding to a content unit in text fragments where the content unit is located, it is possible to determine whether the volume of a content unit in the media file to be played acceleratedly is greater than the average volume of the content source object in the text fragment where the content unit is located and whether the difference between the volume and the average volume is not less than the first audio volume threshold. If so, this content unit may be considered as important information and may be reserved as the key content; otherwise, the content unit may be deleted. The text fragment where the content unit is located may be a sentence or a paragraph of the content.

If the average audio volume is an average volume determined with respect to the content source objects corresponding to the content units in the text content corresponding to the media file to be played acceleratedly, it is possible to determine whether the volume of a content unit in the media file to be played acceleratedly is greater than the average volume of the content source objects and whether the difference between the volume and the average volume is not less than the first audio volume threshold. If so, this content unit may be considered as important information and may be reserved as the key content; otherwise, the content unit may be deleted.

A content unit may be separately determined to be ignored or reserved by using the audio volume of the content unit. A content unit may also be comprehensively determined to be ignored or reserved by using the audio volume of the content unit in combination with the information amount, the part-of-speech, or other factors of the content unit. For example, for the content determined by the part-of-speech to be reserved, the volume of a content unit may be further determined; and the content unit may be reserved as the key content if the volume of the content unit meets the reservation conditions; otherwise, the content unit may be deleted.

IV. Acquisition of Key Content According to Audio Speech Speed

In some speech fragments, a speaker will stress some words by slowing the speech speed for purpose of indicating the importance of these words; conversely, if the speaker says some words in a higher speed, to some extent, that may indicate that the information expressed by these words are not as important. However, merely based on the text analysis, the words slowly spoken by the speaker cannot be regarded as the key content, but the words spoken fast by the speaker may be regarded as the key content. Therefore, the speech speed of a speaker may be analyzed and applied in determining the key content of the speech.

The key content in text content of a media file to be played acceleratedly may be acquired according to the audio speech speed of content units in the text content corresponding to the media file to be played acceleratedly. For example, the granularity of partition of the content units may be a word.

According to the audio speech speed of a content unit in the text content corresponding to the media file to be played acceleratedly, the content unit may be determined to be reserved or deleted. If the audio speech speed of the content unit is not less than a first audio speech speed threshold, the content unit may be reserved as the key content, but if the audio speech speed of the content unit is not greater than a second audio speech speed threshold, the content unit may be deleted.

The first audio speech speed threshold and the second audio speech speed threshold may be determined according to an average audio speech speed of the media file to be played acceleratedly; an average audio volume of text fragments where content units in the text content corresponding to the media file to be played acceleratedly are located; an average audio speech speed of a content source object corresponding to content units in the text content corresponding to the media file to be played acceleratedly; and/or in the text content corresponding to the media file to be played acceleratedly, an average audio speech speed of content source objects corresponding to content units in text fragments where the content units are located.

The content source object may be a speaker in the audio/video, a sounding object, or a source corresponding to the text in electronic text. The first audio speech speed threshold and the second audio speech speed threshold may be determined according to at least one of those average audio speech speeds and preset first and second speech speed threshold factors.

For example, the first audio speech speed threshold and the second audio speech speed threshold may be set with respect to each speaker in the audio to be played acceleratedly. The product of the average audio speech speed and the set first speech speed threshold factor may be confirmed as the first audio speech speed threshold, and the product of the average audio speech speed and the set second speech speed threshold factor may be confirmed as the second audio speech speed threshold.

If the average audio speech speed is an average speech speed determined with respect to the whole media file to be played acceleratedly, it is possible to determine whether the audio speech speed of the content units in the media file to be played acceleratedly is greater than the average speech speed and whether the difference between the audio speech speed and the average speech speed is not less than the first audio speech speed threshold. If so, this content unit may be considered as important information and may be reserved as the key content; otherwise, the content unit may be deleted.

If the average audio speech speed is an average speech speed determined with respect to the text fragments where the content units in the text content of the media file to be played acceleratedly are located, it is possible to determine whether the speech speed of a content unit in the media file to be played acceleratedly is greater than the average speech speed of the text fragment and whether the difference between the speech speed and the average speech speed is not less than the first audio speech speed threshold. If so, the content unit may be considered as important information and may be reserved as the key content; otherwise, the content unit may be deleted.

If the average audio speech speed is an average speech speed determined with respect to, in the text content corresponding to the media file to be played acceleratedly, a content source object corresponding to a content unit in text fragments where the content unit is located, it is possible to determine whether the speech speed of a content unit in the media file to be played acceleratedly is greater than the average speech speed of the content source object in the text fragment where the content unit is located and whether the difference between the speech speed and the average speech speed is not less than the first audio volume threshold. If so, the content unit may be considered as important information and may be reserved as the key content; otherwise, the content unit may be deleted. The text fragment where the content unit is located may be a sentence or a paragraph of the content.

If the average audio speech speed is an average speech speed determined with respect to the content source objects corresponding to the content units in the text content corresponding to the media file to be played acceleratedly, it is possible to determine whether the speech speed of a content unit in the media file to be played acceleratedly is greater than the average speech speed of the content source objects and whether the difference between the speech speed and the average speech speed is not less than the first audio speech speed threshold. If so, the content unit may be considered as important information and may be reserved as the key content; otherwise, the content unit may be deleted.

A content unit may be separately determined to be ignored or reserved by using the audio speech speed of the content unit. A content unit may also be comprehensively determined to be ignored or reserved by using the audio speech speed and audio volume of the content unit. For example, a content unit may be reserved when the audio volume of the content unit meets the reservation conditions and the audio speech speed also meets the reservation conditions; otherwise, the content unit may be deleted. Alternatively, a content unit may be deleted when the audio volume of the content unit meets the deletion conditions and the audio speech speed also meets the deletion conditions; otherwise, the content unit may be reserved.

Further, a content unit may also be comprehensively determined to be ignored or reserved by using the audio speech speed and/or audio volume of the content unit in combination with the information amount, the part-of-speech, or other factors of the content unit. For example, for the content determined by the part-of-speech to be reserved, the audio speech speed and/or volume of a content unit may be further determined; and the content unit may be reserved when the audio volume of the content unit meets the reservation conditions and the audio speech speed also meets the reservation conditions; otherwise, the content unit may be deleted.

V. Acquisition of Key Content According to Content of Interest

According to the content of interest in text content corresponding to a media file to be played acceleratedly, the key content in the text content of the media file to be played acceleratedly may be acquired by reserving corresponding matched content to be the key content if there is content of interest in a preset lexicon of interest matched in the text content; classifying a content unit by using a preset classifier of interest, and reserving the content unit to be the key content if the result of classification is content of interest; deleting corresponding matched content if there is content out of interest in a preset lexicon out of interest matched in the text content; and/or classifying any content unit by using a preset classifier out of interest, and deleting this unit content if the result of classification is content out of interest.

For each content unit of the text content of the media file to be played acceleratedly, the content unit may be reserved as the key content if there is content of interest matched with the content unit in the preset lexicon of interest. Alternatively, the content unit may also be classified by using a preset classifier of interest, and the content unit may then be reserved as the key content if the result of classification is content of interest. Alternatively, it may be determined whether a content unit is key content in conjunction with a lexicon of interest and a classifier of interest.

The content of interest may be acquired in advance. Thereafter, the content of interest is stored to establish a lexicon of interest for expanding, e.g., expanding synonyms, near-synonyms, or others of the content of interest.

When key content is acquired, it is possible to directly match the text content of the media file to be played acceleratedly with the lexicon of interest. When there is content of interest in the lexicon of interest matched in the text content, the content may be selected to as the key content for text simplification. That is, the content may be reserved. It is also possible to model the lexicon of interest and then determine, by a classifier or by other means, whether a content unit in the text content of the media file to be played acceleratedly is the key content for text simplification, i.e., whether the content unit is reserved.

In addition, the content out of interest may also be acquired, and the content out of interest may be set, Thereafter, the content out of interest is stored to establish a lexicon out of interest for expanding, e.g., expanding synonyms, near-synonyms, or others of the content out of interest. Subsequently, with respect to each content unit of the text content of the media file to be played acceleratedly, if there is content out of interest matched with the content unit in the preset lexicon out of interest, the content unit may be deleted. Alternatively, the content unit may be classified by using a preset classifier out of interest, and the content unit may be deleted if the result of classification is content out of interest. The content out of interest may be obtained by user settings and user behaviors, and/or may also be obtained from antonyms of the acquired content of interest.

The key content for text simplification may be separately acquired by using the content of interest or content out of interest. The key content for text simplification may also be comprehensively selected by using both the content of interest and the content out of interest. For example, the content units corresponding to the content of interest are reserved, while the content units corresponding to the content out of interest are deleted.

In addition, the key content for text simplification may also be comprehensively selected by using the content of interest and/or the content out of interest in combination with the information amount, the part-of-speech, audio speech speed, audio volume or other factors of the content units. For example, for the content determined by the part-of-speech to be deleted, it is possible to further determine whether a content unit is matched with the content of interest, and the content unit is reserved when the content unit is matched with the content of interest.

The content of interest may be acquired in advance according to preference settings of a user; an operation behavior of the user in playing the media file; application data of the user on a terminal; and/or the type of media files historically played by the user.

1. Preference Settings of a User.

The preference settings of a user may include the content of interest set by the user through an input operation; and/or the content of interest marked when the user listens to audio, watches a video, reads text content, etc. The operation behavior of a user in playing a media file may be an operation behavior, when the user listens to audio, watches a video, or reads text content. The type of media files historically played by a user specifically may also be the type of the content historically played/read by the user.

The user may set the content of interest and/or content out of interest according to personal interests and habits. For example, a content-of-interest setting interface may be provided in advance. In this interface, the user may set the content of interest and/or content out of interest by at least one of character input, speech input, checking items on the screen, etc. When a user listens to audio, watches a video, or reads text content (including simplified audio, video and text content), the user may mark the content of interest and/or content out of interest touching the screen, sliding the screen, performing a custom gesture, pressing/stirring/rotating a key, etc. After detecting such an operation, the terminal sets the content of interest and/or content out of interest, and/or corrects or updates the acquired content of interest and/or content out of interest.

2. Operation Behavior of a User in Playing a Media File.

The content of interest or content out of interest may be acquired by an operation of triggering the playback, an operation of dragging a progress bar, a pause operation, a play operation, a fast-forward operation, and/or a quit operation.

For example, the content near the temporal position where the playback operation is triggered by the user may be considered as content of interest. Additionally, audio fragments, video fragments, and text fragments that are repeatedly listened by the user may be regarded as content of interest. Content near the temporal position where the pause and playback operation is triggered by the user can be considered as content of interest, and content near the temporal position where the fast-forward operation is triggered by the user may be considered as content out of interest.

3. The Type of Media Files Historically Played by a User.

The content of interest may also be determined by the type of media file historically played by a user. For example, if the content played by the user mostly is content of sports news, it may be determined that the user is interested in sports content, so the content of interest is set according to keywords corresponding to the sports content, and the reservation proportion of sports words is large during determining the key content corresponding to the audio to be played acceleratedly. Similarly, if the programs mostly played by the user are financial programs, it may be determined that the user is interested in financial content, so the content of interest may be set according to keywords corresponding to the financial content, and the reservation proportion of financial words is large during determining the key content corresponding to the audio to be played acceleratedly. If the programs mostly played by the user are scientific programs, it may be determined that the user is interested in scientific content, so the content of interest may be set according to keywords corresponding to the scientific content, and the reservation proportion of hot words related to the scientific field is large during determining the key content corresponding to the audio to be played acceleratedly.

4. Application Data of a User on Terminal.

The content of interest or content out of interest of a user can be acquired according to application data of the user on the terminal, such as the type of applications installed in the terminal by the user, use preferences of the user to applications; and/or browsed content corresponding to the applications.

For example, if a large amount of financial software, such as stock software, is installed in the terminal and/or the financial software is frequently used, the user is likely interested in financial content. Accordingly, the content of interest may be set according to keywords corresponding to the financial content, and the reservation proportion of financial words may be large during determining the key content corresponding to the audio to be played acceleratedly.

If a large amount of sports news software and sports live software are installed in the terminal and/or the sports news software and sports live software are frequently used, the user is likely interested in the sports content. Accordingly, the content of interest may be set according to keywords corresponding to the sports content, and the reservation proportion of sports words may be large during determining the key content corresponding to the audio to be played acceleratedly.

VI. Acquisition of Key Content According to Media File Type.

The key content in text content of a media file to be played acceleratedly may be acquired according to the media file type. Specifically, the content, which is matched with keywords corresponding to the media file type to which the content belongs, in the text content of the media file to be played acceleratedly is reserved as the key content.

As the key content corresponding to different media file types may be different, a corresponding media file type keyword library may be set in advance with respect to each media file type. The media file type keyword library may include a media file type and corresponding keywords.

When the terminal simplifies the text content of the media file to be played acceleratedly in order to acquire the key content, the media file type of the media file to be played acceleratedly may be determined, and then keywords corresponding to the media file type in the preset media file type keyword library are searched. If there is content matching the searched keywords in the text content of the media file to be played acceleratedly, the matching content may be reserved as the key content.

A media file type sign can be set in advance with respect to each media file. When a user confirms the accelerated playback of the media file, the terminal may acquire the media file type sign of the media file and then confirm the media file type of the media file according to the sign.

The key content for text simplification may be separately selected by using the media file type. In addition, the key content for text simplification may also be comprehensively selected by using the media file type and in combination with the information amount, part-of-speech, speech speed, volume or other factors of the words. For example, for the content determined by the part-of-speech to be deleted, it is possible to further determine whether the content is matched with the keywords corresponding to the media file type. The content unit may be reserved when the content matches with the keywords corresponding to the media file type.

For a sports type media file, for example, in a soccer game, “shoot”, “goal”, “foul”, and “red card” may be set as keywords, and in a track and field competition, “sprint”, “start”, and “win” may be set as keywords.

For a travel type media file, the content, for example, places, can be set as keywords.

For a teaching type media file, “Chapter XX”, “Section XX”, and “Item XX” may be set as keywords.

For a voice short message and voice note type audio media file, the content, for example, time, places, and/or characters, may be set as keywords.

VII. Acquisition of Key Content According to Content Source Objects

The key content in text content of a media file to be played acceleratedly may be acquired according to the information about content source objects. For example, the key content may be acquired according to the identity of the content source objects (e.g., speakers) in the text content of the media file to be played acceleratedly, the importance of the content source objects, and the content importance of the text content corresponding to the content source objects.

The identity of each content source object in the media file to be played acceleratedly may be determined, and then the key content in the text content may be acquired by according to the identity of the content source object, by extracting, from the text content of the media file to be played acceleratedly, text content corresponding to a content source object having a specific identify, simplifying the extracted content, and/or

simplifying, based on the identity of the content source object, content of a particular type in the text content of the media file to be played acceleratedly. The particular identity may be determined by the media file type of the media file to be played acceleratedly and/or designated in advance by a user.

The simplifying the extracted text content corresponding to the content source object having a particular identity may include reserving or deleting content units in the extracted content.

The identity of each content source object in the media file to be played acceleratedly may be determined by determining the identity of each content source object according to the media file type; and/or determining the identity of each content source object according to the text content corresponding to the content source object.

It is also possible to determine, according to the content importance of a content unit in the text content of the media file to be played acceleratedly and the object importance of corresponding content source objects, to reserve or delete the content unit. For example, when the media file is an audio/video file, the identity of each speaker in the audio/video may be determined; and the text content of a speaker having a particular identity may be extracted from the text content corresponding to the audio, and the extracted text content may be simplified.

Alternatively, with respect to each speaker in the audio/video, the fusion (e.g., a product) of the importance factor of the speaker and the content importance factor of the content spoken by the speaker may be used as an importance score of the speaker, and then the text content corresponding to the audio may be simplified according to the importance score of the speaker.

For example, the identification of the identity of a content source object can be set according to the media file type. The type and number of content source objects may be preset according to the media file type. For example, an anchor and other speakers may be set in a news program; one or more hosts and one or more program guests may be set in an interview program; one or more main actors and other actors may be set in a TV program; and a host and the audience may be set in a talk show program.

With regard to the identification of the identity of content source objects, the identity of the content source objects may be determined according to the text content corresponding to the content source objects (e.g., the content of speakers). For example, if the spoken content of a speaker takes a large proportion of time, there is a high probability that the speaker is an anchor, a host, a guest, or a main actor. Thereafter, the determination is carried out according to particular words included in the spoken content, for example, the host says “Welcome” and “Please”, while the guest says “I am . . . ”, “the first time”, etc.

After the identity of the content source objects are identified, the text content corresponding to a content source object having a particular identity may be extracted, and the extracted text content may be simplified. For example, for a news program, it is possible to simplify the content of the anchor and ignore and/or delete the corresponding interviews and introduction content. For an interview program, it is possible to reserve and simplify the content of the host or simplify the content of the guest. For a talk show program, it is possible to reserve and simplify the content of the host.

As an example below, in an interview program, there are two speakers, i.e., a host and a guest, where Q is a question of the host and A is an answer of the guest.

Q: As we all known, you are a famous star. Would you please talk about the burdens to a star?

A: There are many burdens for a superstar. Once a person becomes famous, he has to give up freedom and expresses himself by his style.

Q: People can think that the life of stars is full of happiness and honor. Actually, they lead a hard life. Now, how about communicating with audiences?

A: Sure.

As indicated above, the content of the host may be simplified, e.g., as shown below:

Q: You are a star. Would you please talk about the burdens to you?

Q: People can think that the life is full of happiness and honor. Their lives. How about communicating with audiences?

Alternatively, the content of the guest may be simplified, e.g., as shown below:

A: Burdens to a star. A person becomes famous. He gives up freedom and expresses himself.

A: Sure.

Accordingly, when a user confirms the accelerated playback of a media file to be played acceleratedly, the terminal may directly simplify the text content of the media file. In addition, a content source object to be played may also be selected by a user. For example, in an interview program, if the user selects to play the content of the host, the terminal simplifies and plays only the content of the host. The user may indicate the selected content source object by selecting a certain playback position of the media file. For example, if a user requests the accelerated playback of a video, the user can indicate the selected speaker by selecting a character in the played video image, and the terminal may confirms the user selection through the correspondence between the video image content and audio content.

After the identity of each content source object in the text content of the media file to be played acceleratedly is identified, the text content of the media file to be played acceleratedly may further be simplified according to a sentence pattern of the content units in the text content, and the content units having a particular sentence pattern may be reserved as the key content.

For example, if the content spoken by a speaker A is a question and a speaker B answers this question, the content answered by the speaker B should also be reserved when the content spoken by the speaker A is reserved, thereby ensuring the integrity of media information. That is, the answer by another speaker to the question of one speaker shall be reserved. For example, if a host asks a question, this question shall be reserved and the first sentence of the answer shall also be reserved for ease of understanding by the user. When only a certain user is reserved, non-declarative content of other users shall be reserved, such as content having a dramatic change in intonation or a large fluctuation in speech speed.

When a media file is an audio/video file, with respect to each speaker in the audio/video, the fusion (e.g., a product) of the importance factor of the speaker and the content importance factor of the content spoken by the speaker may be used as an importance score of the speaker, and then the text content is simplified according to the importance score of the speaker.

For example, the importance factor Q, of the speaker may be calculated using Equations (1) and (2) below:

$$\begin{matrix}{Q}_{n} = \frac{{\sum }_{T} t ( n )}{{N}_{0}} & ( 1 ) \\ {\sum }_{{N}_{0}} {\sum }_{T} t ( n ) = {N}_{0} & ( 2 )\end{matrix}$$

In Equations (1) and (2), T is the total speaking time duration in the audio/video; N₀ is the total number of speakers in the audio/video; t(n) is the speaking time duration of the n^{th} speaker in the audio/video; N₀ is a positive integer, and n is an integer from 1 to N₀.

The importance factor of the spoken content may be determined according to the semantic understanding technology. When the final importance score of each piece of spoken content is determined, the importance factor of the speaker and the importance factor of the spoken content may be calculated in a set calculation manner.

For example, if four actors are in an ongoing dialogue in a segment of audio from a TV show, the speaker importance factor of each actor may be determined (e.g., the importance can be determined according to the total speaking time duration of different speakers, or can be set in an order as shown in the cast), where the importance factors of the speakers are 0.2, 0.3, 0.1, and 0.4, respectively. For four pieces of spoken content, the content importance factor of each piece of content may be acquired, so that the final importance score of each piece of content is finally obtained. By screening, a preset number of pieces of content having a highest final importance score may be reserved, or the content having a final importance score greater than a preset threshold may be reserved. In Table 1 below, content 1 to content 4 are four sentences spoken by four speakers, respectively, and the final score is the product of the content importance factor and the speaker importance factor.

TABLE 1
Final importance score of spoken content

| | | Speakers | | | | | | | |
|---|---|---|---|---|---|---|---|---|---|
| | | Speaker 1 | | Speaker 2 | | Speaker 3 | | Speaker 4 | |
| | | Importance factor of speakers | | | | | | | |
| | | 0.2 | | 0.3 | | 0.1 | | 0.4 | |
| | | Content | | Content | | Content | | Content | |
| | | importance | Final | importance | Final | importance | Final | importance | Final |
| | | factor | score | factor | score | factor | score | factor | score |
| Content | Content 1 | 0.165 | 0.33 | | | | | | |
| importance | Content 2 | | | 0.358 | 0.107 | | | | |
| | Content 3 | | | | | 0.477 | 0.048 | | |
| | Content 4 | | | | | | | 0.908 | 0.363 |

VIII. Acquisition of Key Content According to Acceleration Rate

The key content in text content of a media file to be played acceleratedly may be acquired according to an acceleration rate. That is, key content in the text content of the media file to be played acceleratedly at the current acceleration rate is determined according to key content in the text content of the media file determined at the previous acceleration rate.

For example, a content unit may be determined to be reserved or deleted according to the proportion of content of each content unit in the key content determined at the previous acceleration rate in the content unit to which the content belongs. Additionally or alternatively, a content unit may be determined to be reserved or deleted according to the semantic similarity between adjacent content units in the key content determined at the previous acceleration rate.

The granularity of partition of the content units in the text content may be determined according to the acceleration rate corresponding to the media file to be played acceleratedly, and the content units of the text content of the media file to be played acceleratedly may be partitioned according to the determined granularity of partition.

Different acceleration rates correspond to different content simplification strategies in order to meet the accelerated playback requirements of different scenarios. Therefore, after the text content is partitioned according to the acceleration rate to obtain content units, for every several content units, one content unit may be selected from the several content units for reservation, e.g., the first content unit is reserved as the key content.

For example, when the accelerated playback is performed at an acceleration rate of 2×, the granularity of partition of the content units may be a word, so the content units are deleted or reserved in units of words. However, when the accelerated playback is performed at an acceleration rate of 3×, the granularity of partition of the content units may be a sentence, so the content units are deleted or reserved in units of sentences. When the accelerated playback is performed at an acceleration rate of 4×, the granularity of partition of the content units may be a paragraph, so the content units are deleted or reserved in units of paragraphs.

For the strategy for deleting and reserving content in units of sentences or paragraphs, an average interval method may be employed directly. For example, only the first sentence may be reserved for every two sentences, or only the first sentence may be reserved for every three sentences.

After the text content is partitioned according to the acceleration rate to obtain the content units, the key content determined at the previous acceleration rate, i.e., the key content determined after simplifying the text content of the media file to be played acceleratedly according to the previous acceleration rate, can be acquired. Because the proportion of the content of each content unit in the key content determined at the previous acceleration rate in the content unit to which the content belongs may be relatively small, it can be reflected to some extent that the importance of this content unit is not that high. Therefore, a content unit may be determined to be reserved or deleted according to the proportion of content of each content unit in the key content determined at the previous acceleration rate in the content unit to which the content belongs. For example, with respect to a content unit, if the proportion of the content of the content unit in the key content determined at the previous acceleration rate in the content unit to which the content belongs exceeds a set reservation threshold, the content unit may be reserved as the key content; but if the proportion of the content of each content unit in the key content determined at the previous acceleration rate in the content unit to which the content belongs is less than the set reservation threshold, the content unit may be deleted.

The previous acceleration rate may be less than the current acceleration rate of the media file to be played acceleratedly. The reservation threshold may be set according to experience by those skilled in the art. For example, the reservation threshold may be set as 50%, 30%, 40%, etc.

A content unit may be determined to be reserved or deleted according to the semantic similarity between adjacent content units in the key content determined at the previous acceleration rate. After the key content determined at the previous acceleration rate is acquired, the acquired key content determined at the previous acceleration rate may be partitioned according to the granularity of partition corresponding to the previous acceleration rate to obtain content units. Thereafter, the semantic similarity between two adjacent content units may be determined by semantic analysis, and if the semantic similarity between the two adjacent content units exceeds a preset similarity threshold, one of the content units (e.g., the first one or the last one) may be reserved as the key content.

According to the acceleration rate, the information on which the acquisition of the key content is based may be selected from the part-of-speech of content units in the text content, the information amount of the content units, the audio volume of the content units, the audio speech speed of the content units, content of interest in the text content, the media file type, and/or information about content source objects. Thereafter, key content in the text content of the media file to be played acceleratedly may be acquired according to the selected information. The rising of the acceleration rate of a media file is consistent with the decrease of the determined key content, and the reduction of the acceleration rate of a media file is consistent with the increase of the determined key content. That is, the higher the acceleration rate of the media file is, the less the determined key content is. Similarly, the lower the acceleration rate of the media file is, the more the determined key content is.

For example, when the simplification is performed at an acceleration rate of 2×, the key content is acquired according to the part-of-speech of the content units in the text content and the audio volume of the content units. When the simplification is performed at an acceleration rate of 3×, the key content is acquired according to the part-of-speech of the content units in the text content, the audio volume of the content units and the audio speech speed of the content units. Alternatively, the key content may be acquired by using the audio speech speed of the content units, on the basis of the text simplified at an acceleration rate of 2×.

When the simplification is performed at an acceleration rate of 2×, the key content may be acquired according to the part-of-speech of the content units in the text content. When the simplification is performed at an acceleration rate of 3×, the key content is acquired according to the part-of-speech of the content units in the text content and the part-of-speech of the content units in the text content. For example, for an interview program, when the playback is performed at an acceleration rate of 2×, all the content may be simplified according to the part-of-speech, i.e., both the content of the guest and the content of the host may be simplified. However, when the playback is performed at an acceleration rate of 3×, only the content of the host may be simplified.

IX. Acquisition of Key Content According to Media File Quality

The key content in text content of a media file to be played acceleratedly may be acquired according to the media file quality.

According to the media file quality, the information on which the acquisition of the key content is based may be selected from the part-of-speech of content units in the text content, the information amount of the content units, the audio volume of the content units, the audio speech speed of the content units, content of interest in the text content, the media file type, and/or information about content source objects. Thereafter, key content in the text content of the media file to be played acceleratedly may be acquired according to the selected information. The information on which the acquisition of the key content is based may also be selected according to at least one of the acceleration rate and the media file quality.

The information on which the acquisition of key content in text content of a media file audio fragment is based may be selected according to the media file quality of any media file audio fragment in the media file.

The media file quality of a media file audio fragment may be determined by determining phoneme and noise corresponding to each audio frame for each audio frame of audio fragments in the media file to be played acceleratedly; separately determining, according to a probability value of each audio frame corresponding to a corresponding phoneme and/or a probability value of each audio frame corresponding to corresponding noise, the audio quality of each audio frame; and determining the media file quality of the media file audio fragment based on the audio quality of each audio frame.

The probability value of an audio frame corresponding to a corresponding phoneme may be obtained by defining that variable δₜ(i) has a path to phoneme Si at moment t, and outputting the maximum probability of an observable sequence O=O₁ O₂ . . . Oₜ as the probability value of an audio frame in the audio content at moment t corresponding to the i^{th} phoneme Si: δₜ(i)=maxP( [symbol] . . . qₜ=Sᵢ, 0₁0₂ . . . 0ₜ|μ). Here, maxP( ) is a function for calculating the maximum probability, q denotes the observable sequence, μ is a given model, t is an integer from 1 to N, and N is the total number of audio frames contained in the audio content.

The probability value of an audio frame corresponding to corresponding noise may be obtained by defining that variable δₜ(i) arrives the state Ni corresponding to the noise at moment t, and outputting the maximum probability of an observable sequence O=O₁ O₂ . . . Oₜ as the probability value of an audio frame in the audio content at moment t corresponding to the state Ni: δₜ(i)=maxP( [symbol] . . . qₜ=Nᵢ, 0₁0₂ . . . 0ₜ|μ). Here, maxP( ) is a function for calculating the maximum probability, q denotes the observable sequence, μ is a given model, t is an integer from 1 to N, and N is the total number of audio frames contained in the audio content.

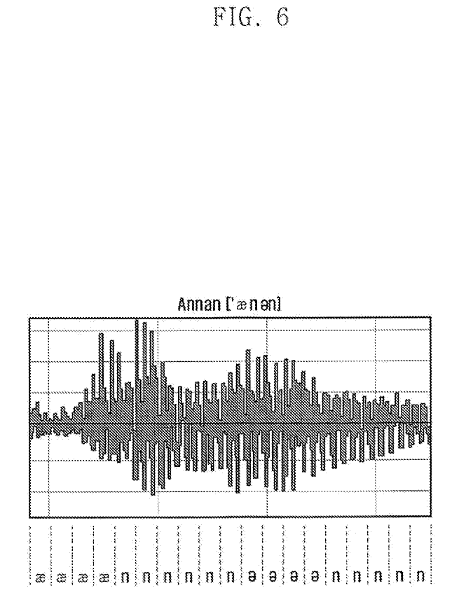

FIG. 6 illustrates phonemes corresponding to audio frames in audio content according to an embodiment of the present disclosure.

Referring to FIG. 6, as the phonetic symbol of English word “Annan” is “[' [symbol] ]”, and in the signal waveform of this word, each frame of signal corresponds to different phonemes “ [symbol] ”, “n” and “ [symbol] ”. Table 2 and Table 3, below, show the probability value of each frame of a signal corresponding to a corresponding phoneme and the probability value of each frame of a signal corresponding to corresponding noise.

TABLE 2
Probability value of each frame of a signal
corresponding to a corresponding phoneme

| Phoneme | Probability | Phoneme | Probability |
|---|---|---|---|
| [symbol] | 0.3514 | [symbol] | 0.7451 |
| [symbol] | 0.4213 | [symbol] | 0.6526 |
| [symbol] | 0.4521 | [symbol] | 0.7845 |
| [symbol] | 0.6511 | [symbol] | 0.8421 |
| n | 0.7815 | n | 0.7564 |
| n | 0.6887 | n | 0.6542 |
| n | 0.8326 | n | 0.3213 |
| n | 0.8412 | n | 0.4123 |
| n | 0.8845 | | |

TABLE 3
Probability value of each frame of a signal
corresponding to corresponding noise

| Phoneme | Probability | Phoneme | Probability |
|---|---|---|---|
| [symbol] | 0.1123 | [symbol] | 0.0025 |
| [symbol] | 0.0065 | [symbol] | 0.0984 |
| [symbol] | 0.0452 | [symbol] | 0.0744 |
| [symbol] | 0.0945 | [symbol] | 0.0698 |
| n | 0.0054 | n | 0.0478 |
| n | 0.0754 | n | 0.0874 |
| n | 0.0985 | n | 0.1065 |
| n | 0.0045 | n | 0.1523 |
| n | 0.0742 | | |

After determining the probability value of the audio frame corresponding to the corresponding phoneme and the probability value of the audio frame corresponding to the corresponding noise, the media file quality of a media file audio fragment may be determined based on the audio quality of each audio frame.

The media file quality of a media file audio fragment may be an average value of the audio quality of audio frames included in the audio fragment. The audio quality of an audio frame may be a probability value of the audio frame corresponding to a corresponding phoneme; a probability value of the audio frame corresponding to corresponding noise; a value (such as a relative value or a ratio or a difference) obtained after operating the probability value of the audio frame corresponding to the corresponding phoneme and a preset probability average value corresponding to the phoneme; or a value (such as a difference or a ratio) obtained after operating the probability value of the audio frame corresponding to the corresponding phoneme and the probability value of the audio frame corresponding to corresponding noise.

Alternatively, the media file quality Q of a media file audio fragment may be calculated using Equation (3).

Q=∫δₜdt (3)

In Equation (3), N is the total number of audio frames contained in the audio content, and δₜ is the probability value of the audio frame at moment t corresponding to a corresponding phoneme.

The media file quality Q of a media file audio fragment may also be calculated according to Equation (4).

Q=∫wₜδₜdt (4)

In Equation (4), N is the total number of audio frames contained in the audio content, δₜ is the probability value of the audio frame at moment t corresponding to a corresponding phoneme, and δₜ is a weight value set by a window function in advance. The window function may be a Hanning window that satisfies

$$w ( t ) = 0.5 [ 1 - cos ( \frac{2 π t}{M + 1} ) ] ,$$

where M denotes the length of the Hanning window sequence.

The media file quality Q of a media file audio fragment may also be calculated using Equation (5).

$$Q = \frac{\int {δ}_{t} dt}{\int {N}_{t} dt} \qquad ( 5 )$$

In Equation (4), N is the total number of audio frames contained in the audio content, t is an integer from 1 to N, δₜ is the probability value of the audio frame at moment t corresponding to a corresponding phoneme, and Nₜ is the probability value of the audio frame at moment t corresponding to corresponding noise.

The media file quality Q of a media file audio fragment can be calculated using Equation (6).

Q=∫(δₜ−Nₜ)dt (6)

In Equation (6), N is the total number of audio frames contained in the media file audio fragment, t is an integer from 1 to N, δₜ is the probability value of the audio frame at moment t corresponding to a corresponding phoneme, and Nₜ is the probability of the audio frame at moment t corresponding to corresponding noise.

After the media file quality of a media file audio fragment in the media file is determined, the information on which the acquisition of key content in text content of the media file audio fragment is based may be selected. The rising of the quality level of the media file quality of a media file audio fragment is consistent with the decrease of the determined key content, and the reduction of the quality level of the media file quality of a media file audio fragment is consistent with the increase of the determined key content. That is, the higher the quality level of the media file quality of a media file audio fragment is, the less the determined key content is. Similarly, the lower the quality level of the media file quality of the media file audio fragment is, the more the determined key content is.

The quality level of the media file quality of the media file audio fragment may include excellent, normal, poor, etc., and may be obtained by comparing the media file quality of the media file audio fragment with a quality level threshold of each quality level. The quality level threshold of each quality level may be determined by the fusion (e.g., a product) of the average quality of the media file and a preset threshold factor of each level. The average quality of the media file is an average value of the media file quality of media file audio fragments.

For an audio fragment having good audio quality, less key content may be extracted, so that the processing efficiency is improved as much as possible while ensuring a user will still understand the semantic meaning, For an audio fragment having poor audio quality, the key content may be extracted as much as possible so that the user will still understand the semantic meaning of the audio through the key content.

For example, the audio quality may be classified into excellent, normal, and poor.

For an audio fragment having excellent audio quality, the content can be simplified by part-of-speech+speech speed+volume. For an audio fragment having normal audio quality, the content can be simplified only by the speech speed/volume. For an audio fragment having very poor audio quality, the audio fragment can be deleted directly.

X. Acquisition of Key Content According to Playback Environment

The key content in text content of a media file to be played acceleratedly may be acquired according to the playback environment of the media file.

According to the playback environment, the information on which the acquisition of the key content is based may be selected from the part-of-speech of content units in the text content, the information amount of the content units, the audio volume of the content units, the audio speech speed of the content units, the content of interest in the text content, the media file type, and/or the information about content source objects. Thereafter, key content in the text content of the media file to be played acceleratedly may be acquired according to the selected information. The information on which the acquisition of the key content is based may also be selected according to the playback environment, the acceleration rate, and/or the media file quality.

The selecting, according to the playback environment, information on which the acquisition of the key content is based includes selecting, according to the noise intensity level of the playback environment of the media file, information on which the acquisition of the key content in the text content of the media file audio fragment is based. The rising of the noise intensity level of the playback environment of a media file is consistent with the increase of the determined key content, and the reduction of the noise intensity level of the playback environment of the media file is consistent with the decrease of the determined key content. That is, the higher the noise intensity level of the playback environment of the media file is, the more the determined key content is. Similarly, the lower the noise intensity level of the playback environment of the media file is, the less the determined key content is.

After receiving an accelerated playback instruction activated by a user, the terminal may detect the current ambient environment in real time by a sound collection equipment (e.g., a microphone) and adaptively select different content simplification strategies according to the noise intensity of the ambient environment in order to meet the accelerated playback requirements of different environments.

For example, when the noise intensity of the ambient environment is low, less key content may be extracted, so that the processing efficiency is improved as much as possible while ensuring a user will still understand the semantic meaning. However, when the noise intensity of the ambient environment is high, the key content may be extracted as much as possible so that the user will still understand the semantic meaning of the audio through the key content.

For example, when the noise intensity of the ambient environment is less than a noise intensity threshold, the key content may be acquired by the part-of-speech, the speech speed and the volume. However, when the noise intensity of the ambient environment is not less than the noise intensity threshold, the key content may be acquired by the speech speed or the volume.

The noise intensity threshold may be set through a preset signal-to-noise ratio threshold, or according to a relative value of the media file quality of the media file to be played acceleratedly and the environment noise intensity. The media file quality of the media file to be played acceleratedly may be determined by an average value of the audio quality of audio frames in the media file.

In addition, the terminal may recommend a proper acceleration rate according to the noise intensity of the ambient environment. For example, when the noise intensity of the ambient environment is low, a high acceleration rate will be recommended, so that a user may understand the semantic meaning of the audio form a small content. However, when the noise intensity of the ambient environment is high, a low acceleration rate will be recommended, so that the user may understand the semantic meaning of the audio more correctly and completely.

When the noise intensity of the ambient environment is unstable, the terminal may adjust the content simplification strategy in real time according to the real-time detected noise intensity. For example, when it is detected that the noise intensity of the environment is low, the content may be simplified by the part-of-speech, the speech speed, and the volume. However, when it is detected in real time that the noise intensity of the environment increases, the content may be simplified only by the speech speed or the volume.

As described above, after a media file corresponding to key content in text content of a media file to be played acceleratedly is determined, the playback strategy of the media file corresponding to the key content may be adjusted according to the environment noise intensity, the media file quality, the speech speed, the volume, the acceleration rate, the positioning instruction, etc.

The description below is directed to how to adjust the playback strategy of the determined media file according to the above factors.

XI. Quality Enhancement of Media File

When the audio quality of a media file is poor, human ears may be unable to identify the content if the media file is played acceleratedly, so quality enhancement may be performed on the part having poor audio quality.

As both the noise and audio signals are temporarily stable, there may be parts having high audio quality or poor audio quality in each audio signal. Based on the measurement of the audio quality of each audio frame, the position of an audio frame having poor audio quality can be determined accurately, and different speech enhancement schemes can be employed accordingly. Different examples of how to determine the audio quality of an audio frame has been described above and will not be repeated here.

After a media file corresponding to the key content in the text content of the media file to be played acceleratedly is determined, quality enhance may be performed on the determined media file based on the media file quality, and thereafter, the quality-enhanced media file may be played.

For example, for an audio frame to be enhanced, speech enhancement may be performed on the audio frame according to enhancement parameters corresponding to the audio quality of the audio frame. For an audio frame to be enhanced, the audio frame may be replaced with an audio frame having a same phoneme as the audio frame. For an audio fragment to be enhanced, the audio fragment may be replaced with an audio fragment generated after performing speech synthesis on key content of the audio fragment.

The audio frame to be enhanced may be an audio frame to be quality-enhanced, which is determined from audio frames included in the media file corresponding to the key content in the text content of the media file to be played acceleratedly.

With respect to each audio frame included in the media file corresponding to the key content, if the audio quality of the audio frame is less than a set first audio quality threshold, it may be considered that the audio quality of the audio frame is poor and the quality enhancement should be performed on the audio frame, so the audio frame may be regarded as an audio frame to be enhanced.

If there are audio frames having high quality and audio frames having poor quality among the audio frames contained in the media file corresponding to the key content, the quality enhancement may be performed on the an audio frame to be enhanced by a high-precision speech enhancement method. For example, the terminal may perform speech enhancement to the audio frame according to the enhancement parameters corresponding to the audio quality of the audio frame, and the parameters used during quality enhancement of different audio frames may be different. Alternatively, an audio frame having high audio quality (e.g., the audio quality is not less than the set first audio quality threshold) and having a same phoneme as the audio frame may also be selected, and the audio frame may be replaced with the selected audio frame.

The audio quality of an audio frame may be a probability value of the audio frame corresponding to a corresponding phoneme; a probability value of the audio frame corresponding to corresponding noise; a value (e.g., a relative value or a ratio or a difference) obtained after operating the probability value of the audio frame corresponding to the corresponding phoneme and a preset probability average value corresponding to the phoneme; or a value (e.g., a difference or a ratio) obtained after operating the probability value of the audio frame corresponding to the corresponding phoneme and the probability value of the audio frame corresponding to corresponding noise.

The audio frame fragment to be enhanced may be an audio fragment to be quality-enhanced, which is determined from audio frames included in the media file corresponding to the key content in the text content of the media file to be played acceleratedly.

With respect to the media file corresponding to the key content, if the audio quality of an audio fragment is less than a set second audio quality threshold, it may be considered that the audio quality of the audio fragment is poor and the quality enhancement needs to be performed on the audio fragment, so the audio fragment may be regarded as an audio fragment to be enhanced.

When all of the audio frames have poor quality in an audio fragment, it may not be possible to enhance the signal quality by a signal processing method, and it also may not be possible to find an audio frame having a same corresponding phoneme and high quality for replacement. In this case, a corresponding audio fragment may be generated for replacement according to the key content of the audio fragment by speech synthesis.

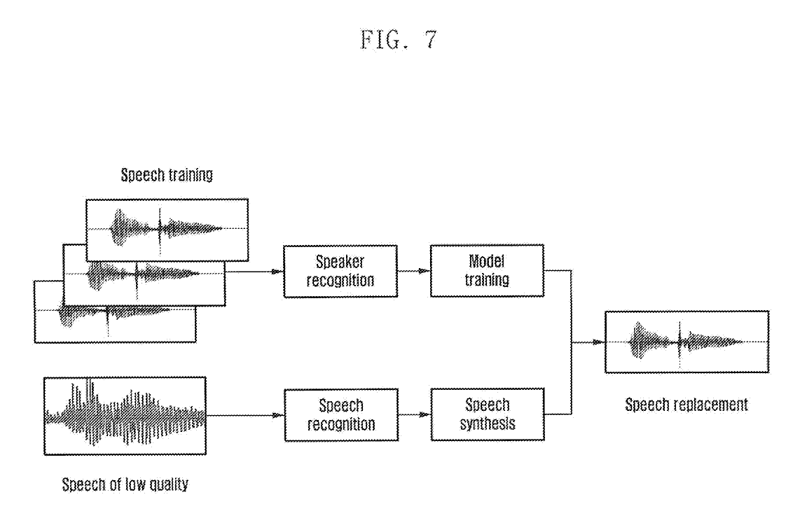

FIG. 7 illustrates speech enhancement through a speech synthesis model according to an embodiment of the present disclosure.

Referring to FIG. 7, after speech recognition is performed on the audio fragment to be enhanced, a preset speech synthesis model is input, and the audio fragment to be enhanced is replaced with an audio fragment generated after the speech synthesis by the speech synthesis model. The speech synthesis model may be obtained by speech training, recognition of a speaker, and/or model training in advance.

The relative audio quality Qₙ of an audio fragment may be determined using Equations (7) and (8).

Qₙ−∫(δₜ−Nₜ)dt/Q̅ (7)

Q̅−∫∫(δₜ−Nₜ)dtdn/N′ (8)

In Equations (7) and (8), N′ is the total number of audio fragments included in the media file corresponding to the key content in the text content of the media file to be played acceleratedly, Q̅ is the average audio quality of audio fragments, δₜ is a probability value of the audio frame at moment t corresponding to a corresponding phoneme, Nₜ is a probability value of the audio frame at moment t corresponding to corresponding noise, and n is the number of audio frames in the audio fragment.

XII. Adjustment of Playback Speed and/or Playback Volume

The corresponding playback speed and/or playback volume may be determined based on information of the media file corresponding to the key content in the text content of the media file to be played acceleratedly, such as audio speech speed, audio volume, content importance, media file quality, and/or playback environment. Subsequently, the media file corresponding to the key content may be played at the determined playback speed and/or playback volume.

1. A Corresponding Playback Speed and/or Playback Volume Maybe Determined Based on the Media File Quality of the Media File.

For a same fast playback speed requirement (at a given playback acceleration rate), different strategies may be employed. When the media file quality of a media file is high, the playback speed of each audio fragment may be quickened as fast as possible, so that more key content is reserved, and/or the playback volume of each audio fragment may be increased.

However, when the media file quality of the media file is low, the playback speed and/or playback volume of each audio fragment remains unchanged, or the playback speed and/or playback volume of each audio fragment is lowered, so that the playback quality of the audio is ensured as much as possible for ease of understanding by the user.

For example, if the media file quality of the media file is greater than a preset third audio quality threshold, each audio fragment will be played at a first playback speed, but if the media file quality of the media file is less than the third audio quality threshold, each audio fragment will be played at a second playback speed.

The first playback speed may be the fusion (e.g., a product) of an accelerated speed indicated by the accelerated playback instruction and the preset first accelerated playback factor. The second playback speed may be the fusion (e.g., a product) of the acceleration rate indicated by the accelerated playback instruction and the preset second accelerated playback factor, where the second accelerated playback factor is less than the first accelerated playback factor.

For example, for an instruction of playing at an acceleration rate of 3×, with respect to a speech signal having high media file quality, the playback speed of each audio fragment may be raised to 1.5×. However, with respect to a speech signal having poor media file quality, the playback speed of each audio fragment remains unchanged or is slowed down to 0.8×.

If the media file quality of the determined media file is unstable, with respect to each audio fragment of the determined media file, the playback speed corresponding to the audio quality of the audio fragment may be separately calculated according to the acceleration rate indicated by the accelerated playback instruction, and the audio fragment may be played at the calculated playback speed.

2. A Corresponding Playback Speed and/or Playback Volume May be Determined Based on the Playback Environment of the Media File.

With respect to a media file corresponding to the key content in the text content of the media file to be played acceleratedly, for a same acceleration rate requirement, different playback strategies may be employed according to the environment noise intensity of the ambient playback environment.

(a) When the environment noise intensity is low, the playback speed of each audio fragment is quickened so that more content is reserved and/or the playback volume is increased.

(b) When the environment noise intensity is high, the playback speed and/or playback volume of each audio fragment is lowered, so that the playback quality of the audio is ensured.

Therefore, the noise intensity of the surrounding environment may be acquired. Thereafter, the playback speed and/or playback volume corresponding to the environment noise intensity may be calculated according to the acceleration rate indicated by the accelerated playback instruction, and the media file determined by the simplified audio may be played at the calculated playback speed and/or playback volume.

In addition, the purpose of adjusting the playback speed may also be achieved by compressing the time of blank fragments.

3. A Corresponding Playback Speed and/or Playback Volume May be Determined Based on the Audio Speech Speed/Audio Volume of the Media File.

For some reasons, such as for emphasis, there may be too fast/too slow fragments or fragments having too high/too low speech intensity in an audio, such that the audio should be processed before fast playback or browsing, thereby ensuring the stability of the whole audio.

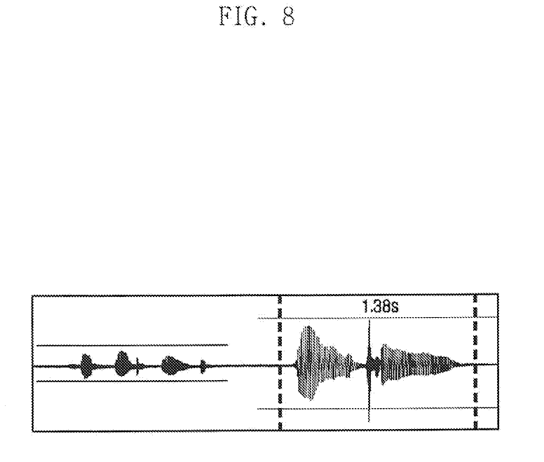

FIG. 8 illustrates fragments having speech amplitude and speed that do not correspond with an average level, according to an embodiment of the present disclosure.

Referring to FIG. 8, fragments have amplitudes and speech speeds which do not correspond with the average level because a word is greatly lengthened due to the emphasis of the speaker, and the sound intensity is very high. However, for a user to feel comfortable and clear during fast playback and browsing, the audio should be normalized, e.g., by adjusting the intensity (volume) of the speech according to an average speech intensity (average volume), and adjusting the length (speech speed) of the speech according to an average speech speed, so as to obtain the normalized speech.

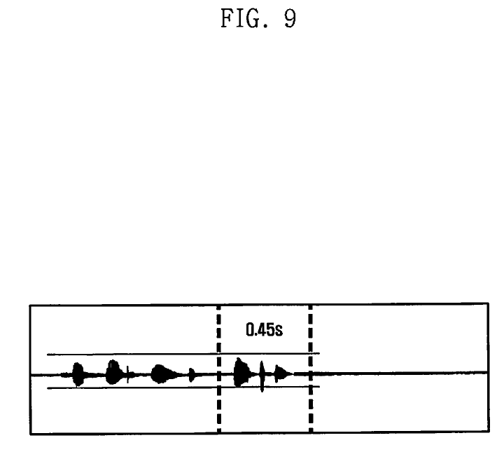

FIG. 9 illustrates fragments that are subject to amplitude and speed normalization of speech, according to an embodiment of the present disclosure.

Referring to FIG. 9, the fragments therein represent the fragments of FIG. 8, after normalization.

After a media file corresponding to the key content in the text content of the media file to be played acceleratedly is determined, the average speech speed of the determined media file may be acquired, the playback speed corresponding to the acquired average speech speed may be calculated according to the acceleration rate indicated by the accelerated playback instruction, and the determined media file may be played at the calculated playback speed.

Alternatively, an average audio speech speed and an average audio volume of the determined media file may be acquired according to the audio speech speed and audio volume of each audio frame in the determined media file, and each audio frame in the determined media file may be played at the acquired average audio speech speed and the acquired average audio volume.

4. A Corresponding Playback Speed and/or Playback Volume May be Determined Based on the content importance of the media file.

During the accelerated playback, the playback may be performed at different speeds and/or volumes according to the importance level of the key content. Content having low importance may be played at a fast speed, while content having high importance may be played at an unchanged playback speed or at a low speed. The importance of the content of the media file may be determined according to the semantic understanding and analysis and in combination with the relevance or repetitiveness between the semantic meaning of the current audio fragment content and semantic meaning of the whole play file and the relevance or repetitiveness between the semantic meaning of the current audio fragment content and the direct content of the context.

For example, after a media file corresponding to the key content in the text content of the media file to be played acceleratedly is determined, the content importance of each content unit in the key content may be acquired. Thereafter, with respect to each content unit, the playback speed and/or playback volume corresponding to the content importance of the content unit may be calculated according to the acceleration rate indicated by the accelerated playback instruction, and the media file corresponding to the content unit may be played at the calculated playback speed and/or playback volume.

XIII. Positioned Playback of Media File

To ensure the understandability of the media file corresponding to the key content in the text content of the media file to be played acceleratedly, when a user executes an positioning operation, the terminal may perform playback from the beginning of a sentence/paragraph, corresponding to the content at the current position, in the text content of the media file in order to avoid information omission.

For example, for a sentence “leaders organize to hold a Politburo meeting”, the simplified content is “leaders hold a Politburo meeting”. When a user listens to “meeting” and positions the media to playback from this position, in order to ensure that the user can correctly understand the full meaning of the current sentence during the playback, the playback starts from “leaders”.

After a media file corresponding to the key content in the text content of the media file to be played acceleratedly is determined and after a positioning instruction is detected, the playback starts from the initial position of a media file fragment corresponding to the content positioned by the positioning instruction, thereby improving the understandability of the content played acceleratedly.

As described above, the accelerated playback of a media file is performed by simplifying content, instead of compressing the playback time. The key information of the original content is reserved in the simplified content, so that the integrity of information is ensured. Accordingly, the user may acquire the key content of the audio even if the playback speed is very fast. In addition, while playing the simplified content, the playback speed may be adjusted by the speech speed estimation and the audio quality estimation of the original audio in combination with the requirements of the accelerated playback efficiency, so that the user can clearly understand the audio content at this speed.

When a media file is a video file, the media file usually includes audio content and image content. Therefore, the accelerated playback of the media is related to the accelerated playback of the audio content, and the accelerated playback of the image content.

Acquiring key content in text content of a video file to be played acceleratedly may include determining key content of audio content of the video file according to the audio content and image content of the video file; determining key content of the image content of the video file according to the audio content and image content of the video file; determining key content corresponding to the video file according to at least one of the video file type, the audio content of the video file, and the image content of the video content; and/or determining key content corresponding to the video file according to the type of audio content and/or the type of image content of the video file.

Key content of audio content of the video file may be determined according to the audio content and image content of the video file.

As described above, the content simplification may be performed according to different media content and different scenarios by using different strategies so as to acquire key content. The scenario in the video file is essentially unchanged, and the image content changes slowly. When the audio content includes a large dialogue, simplification may be performed according to the audio content to determine the key content of the audio content of the video file.

Specifically, when the audio content in a video file is mainly environment noise and background music, or the speech content per unit time is less while both the scenario and the image content in the video file change fast, content simplification may be performed according to the image content to determine the key content of the image content of the video file.

Key content corresponding to the video file may also be determined according to at least one of the video file type, the audio content of the video file, and the image content of the video content.

The common key text content of the text content of the media file to be played acceleratedly and a video type keyword library may be searched by using the video type keyword library corresponding to the video file type of the media file, and then the searched key text content may be reserved as the key content. The text content of the media file may be determined based on the text content, audio content, and/or image content included in the video file.

For example, in a news program, the image content is determined according to fixed trailers, title/end picture background, etc., the audio content is determined according to “start”, “end”, and other keywords, and the key content is comprehensively determined therefrom. In a sports program, the key picture content is set according to different item types of sport items, the key content of the audio is determined according to terms of different sport items, and the key content is comprehensively determined therefrom.

For example, in a soccer game, key pictures generally include red cards or yellow cards, players, ball and goal appearing together, and/or several players appear in a small scope.

The key audio content generally includes “pass”, “shoot”, “foul”, “goal”, etc.

The content of background commentary is continual in the soccer game, but there is really not that much content related to the actual game. Therefore, according to the above method for determining key information in a video file in combination with audio content and video image content, the key content within a period of the game may be quickly extracted in deciding fragments in which a “red card” appears according to the images, deciding fragments in which “shoot” appears according to the audio, and deciding fragments in which “pass” appears according to the audio.

Key content corresponding to a video file may also be determined according to the type of audio content and/or the type of image content of the video file.

For example, audio fragments of a designated audio type may be recognized from the audio content of the video file according to a preset audio type training model library and then reserved as the key content. The sound type of a natural background may be thunder, heavy rain, gale, etc., the sound type of sudden events may be a violent crash, braking, etc., and the non-speech type from characters may be scream, cry, etc.

The key content corresponding to the video file may be determined according to the type of image content of the video file. Specifically, image fragments of a designated image type may be recognized from the image content of the video file according to a preset image type training model library and then reserved as the key content. For example, the natural image type may be lightning, volcanic eruption, heavy rain, etc., the image type of sudden events may be traffic accident, building collapse, etc., and the type of sudden changes of a character state may be running suddenly, faint, etc.

Further, for a large amount of sounds or images of a special type, which appear continuously within a short period of time, a decision can be performed in combination with the audio content and image content near these sound or image positions. If the sounds or images are related to the progress of the media content, the sounds or images may be reserved as the key content.

After the key content corresponding to the video file is obtained, the determined media file can be played by extracting, in the image content of the video file, image content corresponding to the key content of the audio content according to a correspondence between the audio content and the image content, and synchronously playing audio frames corresponding to the key content of the audio content and image frames corresponding to the extracted image content. The number of image frames played per unit time and the number of audio frames played per unit time can be increased according to the requirements on the playback speed of accelerated playback if it is required to continue the accelerated playback of the simplified video file. The determined media file may also be played by playing the audio frames corresponding to the key content of the audio content, and playing the image frames of the video file at an acceleration rate, where the image content and the audio content cannot be synchronous, and playing the audio frames corresponding to the key content of the audio content and the image frames corresponding to the key content of the image content, where the image content and the audio content cannot be synchronous.

When a media file is an electronic text file, key content in text content of the electronic text file may be acquired according to information corresponding to the electronic text file, such as the part-of-speech of content units, the information amount of content units, the content of interest in the text content, the information about content source objects, the acceleration rate, etc.

After the key content in the text content of the electronic text file to be played acceleratedly is acquired, a media file corresponding to the key content, i.e., an electronic text file corresponding to the key content, is determined. Subsequently, the determined media file may be played by displaying full text content, and highlighting the key content (for example, displaying with a different font, displaying with a different color, bolding, rendering, etc.); displaying full text content, and weakening non-key content (for example, strikethrough, etc.); or displaying only the key content.

A user may quickly position to the content of interest and exit the simplified display mode by touching the screen, sliding or other operations. For example, when the user browses the key content and if the user positions to the content-of-interest “indicate” by touching the screen, sliding or other operations, the terminal may exit the simplified display mode and display the full text content. While displaying the full text content, the key content can be highlighted, or the non-key content may be weakened. In addition, for convenience of user viewing, the display mode of the full text content may also be adjusted. The content of interest positioned by the user may be placed at the central position of the display screen or at the visual focus of the user. After a positioning instruction is detected, the playback starts from an initial position of a media file fragment corresponding to the content positioned by the positioning instruction.

When a media file is an electronic text file and an audio file, key content in the text content of the media file to be played acceleratedly may be displayed according to a display capability of a device.

For a device having a large display space, such as an e-book equipment, a tablet computer and more, full text content may be displayed and the key content maybe highlighted, the full text content may be displayed and the non-key content may be weakened, or only the key content may be displayed. In addition, the currently played content of the audio may be marked and displayed, while displaying the text.

For a device having a limited display space on the screen, such as the curved screen portion of a smart phone, the screen of a smart watch, etc., the text may be displayed according to the actual display space, e.g., displaying linear or annular display text, and the quick browsing and positioning operation may be provided in cooperation with a gesture, a physical key, or other operations.

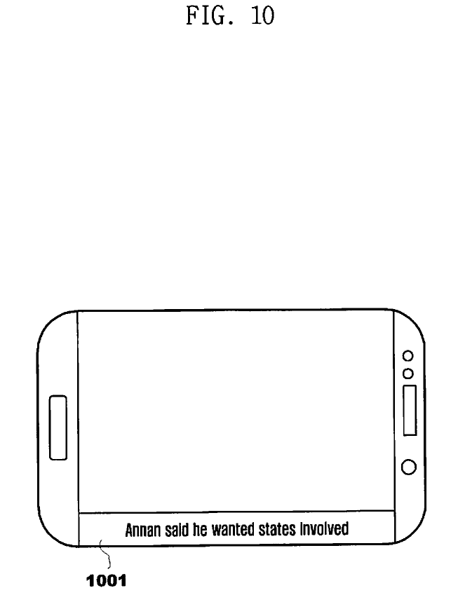

FIG. 10 illustrates a display of simplified text content using a screen in a side screen portion according to an embodiment of the present disclosure.

Referring to FIG. 10, a mobile phone having a side screen 1001 displays by using the screen of the side screen 1001 to assist the quick playback and browsing of the audio, reducing power consumption. For example, forward/backward of the content (text and/or audio) may be performed by sliding the text in the side screen 1001 left and right; the content of the previous/next sentence/paragraph can be viewed by sliding the text in the side screen 1001 up and down; the fast-forward/rewind of the content at different rates may be performed by different sliding speeds; and the quick positioning of the content may be performed by selecting or other touch operations. Thus, after a user selects certain text content in the text in the side screen 1001, the terminal may perform quick positioning on the audio according to the text content selected by the user, and position to an audio position corresponding to the text content.

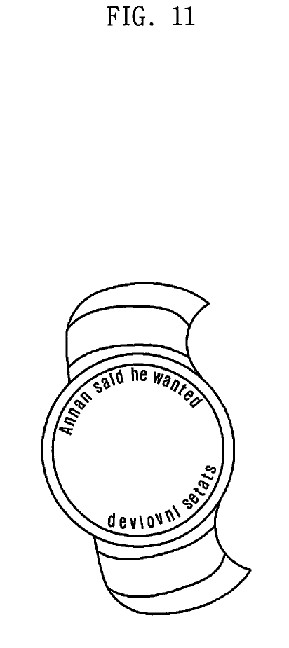

Referring to FIG. 11, a peripheral portion of a screen of the watch is used to assist the quick playback and browsing of the audio. For example, forward/backward of the content (text and/or audio) may be performed by stirring the dial clockwise/counterclockwise or by a clockwise/counterclockwise slide gesture; the content of the previous/next sentence/paragraph may be viewed by a physical key or a virtual key; the fast-forward/rewind of the content at different rates may be performed by different stirring speeds; and/or quick positioning of the content may be performed by selecting or other touch operations. Thus, after a user selects certain text content, the terminal may perform quick positioning on the audio according to the text content selected by the user, and position the audio to a position corresponding to the text content.

When the media file is an electronic text file and a video file, key content in text content of the media file to be played acceleratedly may be acquired by determining key content according to the text content of the electronic text file, and/or determining key content according to text content corresponding to audio content of the video file.

After the key content in the text content of the media file to be played acceleratedly is determined, the determined media file may be played by extracting audio content and/or image content corresponding to the key content of the text content and playing the extracted audio content and/or image content; playing key content of the text content and playing key audio frames and/or key image frames of the identified video file; and playing key content of the text content and playing image frames and/or audio frames of the video file at an acceleration rate.

The text content may be acquired according to the subtitles (e.g., an electronic text file) of the video file. The text content acquired according to the subtitles of the video may not include the temporal position information of each word.

After the key content in the text content of the media file to be played acceleratedly is acquired, a temporal position of the image content corresponding to the key content may be calculated, and the image content corresponding to the key content may be played based on the calculated temporal position. For example, if the subtitles corresponding to certain images are the same, and after the text content corresponding to the subtitles is simplified, the temporal position of a video frame image corresponding to the simplified key content may be determined according to the position of the simplified key content in the subtitles and the proportion of the number of words of the simplified key content in the subtitles.

Alternatively, after the key content in the text content of the media file to be played acceleratedly is acquired, key video frame images may be determined by image analysis and the video frame image corresponding to the key content may be played. The video image playback may incompletely correspond to the simplified subtitles. In this case, the image playback is a result of the image processing and analysis, while the subtitles are the simplified key content, so the images and subtitles played at this moment are not in one-to-one correspondence, with the purpose of enabling a user to acquiring the key information of the video simultaneously through the image changes and brief text. When a user interrupts, selects, or stops the quick browsing or playback, the playback position is selected by a user or pre-selected by a system to be positioned according to the image content or the video position corresponding to the simplified subtitles.

Alternatively, after the key content of the text content of the media file to be played acceleratedly is acquired, all images of the video may be played fast, and only the simplified subtitles, i.e., the acquired key content, are displayed.

If the subtitles of the original video are embedded into the images, the original subtitles may be covered or shielded, e.g., by shadow bars, and then the simplified subtitles may be displayed on the covered regions. If the subtitle information and the images of the original video are separated, the simplified subtitles may be directly displayed.

Subsequently, the user may quickly position playback to the corresponding position of the video through the simplified subtitles.

As the subtitles have been completely synchronized with the audio positions in the video at this time, the audio and video position corresponding to a character may be directly positioned by clicking this character, and the audio/video position corresponding to the next piece of subtitles/multiple pieces of subtitles may be quickly positioned directly, e.g., by sliding or shaking the mobile phone.

In addition to the text related information being acquired by the subtitles of the video, the text related information may also be automatically recognized according to the audio in the video. In addition to the text content, the text related information may also precisely correspond to the temporal position information of each word and each character in the text content.

Thus, subsequently, the corresponding video content may be accurately acquired according to the temporal position information through the simplified text content, and then played synchronously. The video content includes audio and video images.

All images of the video may be played quickly, and the simplified subtitle content may be displayed.

Alternatively, the corresponding position of the video may be quickly positioned through subtitles. After a user selects certain content in the subtitles, the terminal may perform quick positioning on the video according to the content selected by the user, and position playback to a video position corresponding to the content.

The acquisition solution of key content may be applied in the accelerated playback of a media locally or from a server, and may also provide the compressed transmission of a media file according to actual needs, in order to reduce requirements on the network environment by transmission. For example, if device A is to transmit audio to device B, but the current network state is poor or the storage space of device B is small, device A may first simplify the media file according to the above-described methods and then transmit the simplified media file to device B.

In addition, a media file may be according to the above-described methods while storing the media file. As described above, the simplified media file corresponds to key content in text content of a media file to be played acceleratedly.

Simplification and storage may also be performed by a device for receiving a media file. For example, after device C receives a media file from another device and should store this media file, but device C is unable to store the complete media file because the current storage space of device C is very small, device C may simplify the media file and then store the simplified media file.

The media file may also be simplified by the device sending the media file, before transmission. For example, if device A is to transmit audio to device B, but the storage space of device B is small, device A may first simplify the media file and then transmit the simplified media file to device B.

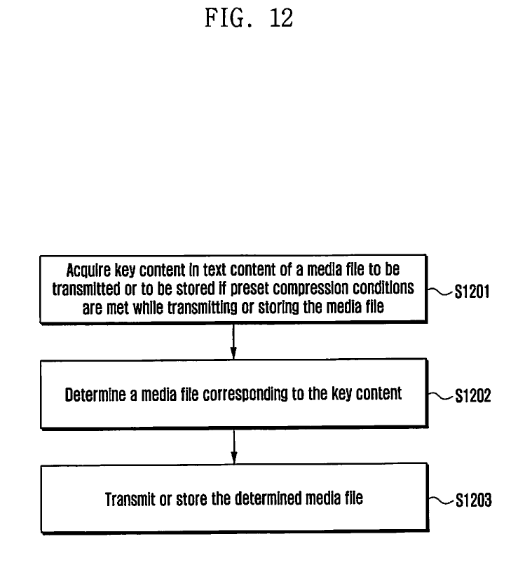

FIG. 12 illustrates a method for compressing and storing a media file according to an embodiment of the present disclosure.

Referring to FIG. 12, in step S1201, key content in text content of a media file to be transferred or stored is acquired, if preset compression conditions are met while transmitting or storing the media file.

Whether the compression conditions are met may be determined by information about a storage space of receiver equipment; and/or the state of a network environment.

For example, the compression conditions may be the occupation space of the media file to be transmitted or stored is greater than the storage space of the receiver device; the storage capacity of the receiver device is small, e.g., less than a preset storage space threshold; or the state of the network environment of the receiver device is poor, e.g., the transmission rate is lower than a preset rate threshold. In this case, the key content in text content of the media file to be transmitted or stored may be acquired as described above.

In step S1202, a media file corresponding to the key content in the text content of the media file to be transmitted or stored is determined. For example, the media file corresponding to the key content in the text content of the media file to be transmitted or stored may be referred to as a compressed media file.

In step S1203, the determined media file is transmitted or stored.

After the determined media file is transmitted, the full content of the media file may be transmitted to the receiver equipment when the receiver device meets preset complete transmission conditions.

Whether the complete transmission conditions are met may be determined by a request for supplementing full content sent by the receiver device; or the state of a network environment.

The state of the network environment refers to a transmission state between a sender/receiver and a server. The sender/receiver may select a proper transmission strategy according to the current network state between the sender/receiver itself and the server.

For example, if the receiver detects that the network state between the receiver and the server is good, the receiver may send a request for supplementing full content to the sender, and the sender may transmit the full content of the media file to the receiver, upon reception of the request. Alternatively, if the sender detects that the network state between the sender and the server is good, the sender may transmit the full content of the media file to the receiver.

The full content of the media file to be transmitted may be transmitted to the receiver device gradually. With respect to each level, the recognized text content may be simplified by using the simplification corresponding to this level, in order to generate the simplified text content corresponding to the level. Thereafter, the simplified audio corresponding to the level may be used as the content to be transmitted in the level and may be transmitted to the receiver device.

According to the level of the current transmission of the media file, the information on which the acquisition of the key content is based is selected from the part-of-speech of content units in the text content, the information amount of the content units, the audio volume of the content units, the audio speech speed of the content units, the content of interest in the text content, the media file type, and/or the information about content source objects.

Key content in the text content of the media file to be played acceleratedly is acquired according to the selected information.

For example, when the network condition is general, the sender device can first send the simplified media file to the receiver device. If the receiver device wants to further acquire full text after viewing the simplified media file, the receiver device can send a request for supplementing full content (for example, by a key, speech, or in other ways).

Upon reception of the request, the sender device can send the full content to the receiver device, or gradually supplement the full content. The content supplement of different levels can be realized by acquiring key content as described above. For example, the key content obtained by the strategy of part-of-speech+speech speed+volume may be sent first, the key content obtained by the strategy of part-of-speech+speech speed/volume is sent next, and finally, the key content obtained by the strategy of the part-of-speech is sent.

The sender device can send the full content to the receiver device upon reception of the request for supplementing full content, and can also automatically supplement the full content to the receiver device when detecting that the network state is fluent.

The specific implementation of steps S1201 to S1203 of the method illustrated in FIG. 12 may include the operations performed in steps S401 to S403 of FIG. 4, and therefore, will not be repeated here.

The adaptive adjustment strategies for different storage capabilities and network states of a device will be detailed below.

Mode 1: Adjustment of Transmission and Storage Flow According to the Storage Capability of the Device

Generally, a wearable intelligent device (e.g., a smart watch) does not store a lot of media files due to its small storage space. In addition, a smart phone may have insufficient storage space. However, the simplified media content as described herein can be stored in such devices due to small space occupation. Therefore, in view of different storage space states of different devices, different transmission and storage strategies may be applied to complete the fast playback and browsing operations.

While transmitting content, a sender device may inquire about the storage capacity of the receiver device before sending the content. If the receiver device has a storage space for storing the full content, the sender device may send the full content. However, if the receiver device has no storage space for storing the full content, but only a storage space for storing the simplified content, the sender device may first simplify the content and then transmit the simplified content. In addition, the sender device may also determine the storage capacity according to the device type of the receiver device. For example, if the device type is a smart watch, the storage capacity may be small and only the simplified content is sent in this case, but if the device type is a smart phone, the storage capacity may be large enough for the full content to be sent.

The sender device may also send the full content to the receiver device, and the receiver device may then select to store the full content or the simplified content according to its own storage capacity.

The following description is directed to examples in which content is transmitted to a smart phone by a cloud server, content is transmitted to a smart watch by a cloud server, and content is transmitted to a smart watch by a smart phone.

In the examples blow, as shown in Table 4.1, Table 4.2, Table 4.3, and Table 4.4, the smart watch is permitted to store the simplified content when the preset storage space of the smart watch is large, but the smart watch merely displays the content in real time without storing the content, when the storage space is small. In addition, when the smart watch has a large storage space and has a storage space for storing the full content, the smart watch can store the full content, but when the smart watch has no storage space for storing the full content and only enough storage space for storing the simplified content, the smart watch stores the simplified content. When the smart watch has no storage space for storing the simplified content, the smart watch merely displays the content in real time without storing the content.

TABLE 4.1

| | Device | Storage | |
|---|---|---|---|
| Cases | type | space | Implementation operation |
| 1.1 | Cloud | — | Transmit full content to a smart phone; or |
| | server | | Transmit full content to a smart watch; or |
| | | | Simplify content and transmit the |
| | | | simplified content to a smart watch |
| | Smart | Large | Store full content; |
| | phone | | Transmit full content to a smart watch; or |
| | | | Simplify content and transmit the |
| | | | simplified content to a smart watch |
| | Smart | Large | Store the simplified content if |
| | watch | | receiving the simplified content; |
| | | | Simplify content and store the |
| | | | simplified content if receiving the |
| | | | full content |

TABLE 4.2

| | Device | Storage | |
|---|---|---|---|
| Cases | type | space | Implementation operation |
| 2.1 | Cloud | — | Transmit full content to a smart phone; or |
| | server | | Transmit full content to a smart watch; or |
| | | | Simplify content and transmit the |
| | | | simplified content to a smart watch |
| | Smart | Large | Store full content; |
| | phone | | Transmit full content to a smart watch; or |
| | | | Simplify content and transmit the |
| | | | simplified content to a smart watch |
| | Smart | Small | Just display the full content/simplified |
| | watch | | content in real time, without storing |
| | | | the full content/simplified content |

TABLE 4.3

| | Device | Storage | |
|---|---|---|---|
| Cases | type | space | Implementation operation |
| 3.1 | Cloud | — | Transmit full content to a smart phone; or |
| | server | | Simplify content and transmit the |
| | | | simplified content to a smart phone |
| | | | Transmit full content to a smart watch; or |
| | | | Simplify content and transmit the |
| | | | simplified content to a smart watch |
| | Smart | Small | Store the simplified content if receiving the |
| | phone | | simplified content; simplify content and |
| | | | store the simplified content if receiving the |
| | | | full content; or do not store content |
| | | | Transmit the simplified content to a smart |
| | | | watch; or |
| | | | Transmit full content to a smart watch |
| | Smart | Large | Store the simplified content if receiving |
| | watch | | the simplified content; |
| | | | Simplify content and store the simplified |
| | | | content if receiving the full content. |

TABLE 4.4

| | Device | Storage | |
|---|---|---|---|
| Cases | type | space | Implementation operation |
| 4.1 | Cloud | — | Transmit full content to a smart phone; or |
| | server | | Simplify content and transmit the simplified |
| | | | content to a smart phone; |
| | | | Transmit full content to a smart watch; or |
| | | | Simplify content and transmit the simplified |
| | | | content to a smart watch |
| | Smart | Small | Store the simplified content if receiving the |
| | phone | | simplified content; simplify content and store |
| | | | the simplified content if receiving the full |
| | | | content; or, do not store content |
| | | | Transmit the simplified content to a smart |
| | | | watch; or |
| | | | Transmit full content to a smart watch |
| | Smart | Small | Just display the content in real time, |
| | watch | | without storing the content |

Mode 2: Determination of Media Content Transmission Strategies According to a Network State

The state of network environment may also be determined according to the network signal intensity, network transmission speed, and/or network transmission speed stability. If the network condition is not fluent, the fast playback and browsing operation of the flow may be realized by transmitting the simplified content or compressed data. The network state refers to a transmission state between a sender/receiver and a server. The sender/receiver may select a proper transmission strategy according to the current network state between the sender/receiver itself and the server.

When the network condition is fluent, the corresponding transmission strategy is to transmit full media content to the receiver equipment. When the network condition is general, the corresponding transmission strategy is to first transmit a simplified media file and then supplement the full content gradually, or perform piecewise compression and transmission on a media file, where a high compression rate is used for the data of high quality while a low compression rate is used for the data of low quality.

When the network condition is poor, the corresponding transmission strategy is to merely transmit the simplified media file or the key content, and the receiver device locally synthesizes and generates a media file corresponding to the key content.

Mode 3: Determination of Data Transmission Strategies During a Speech/Video Call According to a Network State

The fast playback and browsing operation of the speech may be performed based on the network state of a voice call, such as an Internet protocol (IP) call, a voice over IP (VOIP), and/or a telephone conference over the network.

When the network condition is fluent, the corresponding transmission strategy is that the devices of both communication parties transmit a full audio/video to a server and the server transmits the full audio/video of a communication party to the opposite party.

When the network condition is general, the corresponding transmission strategy is to first transmit the simplified content and then supplement the full content gradually, or perform piecewise compression and transmission to the audio/video, where a high compression rate is used for the data of high quality while a low compression rate is used for the data of low quality.

When the network condition is poor, the corresponding transmission strategy is to transmit the simplified media file or the simplified text content, and the receiver device locally synthesizes and generates an audio by using the speech.

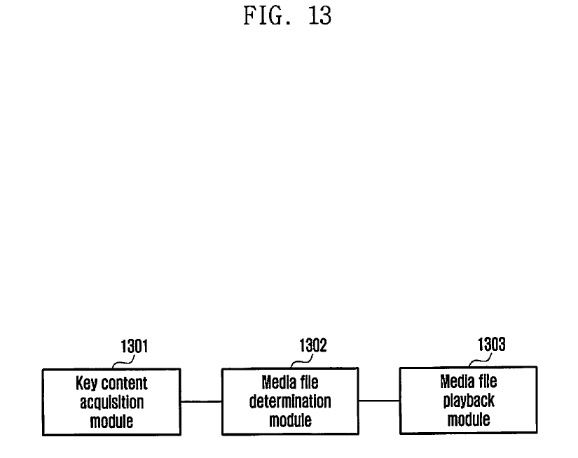

FIG. 13 illustrates a device for accelerated playback of a media file according to an embodiment of the present disclosure.

Referring to FIG. 13, the device includes a key content acquisition module 1301, a media file determination module 1302, and a media file playback module 1303.

The key content acquisition module 1301 is configured to acquire key content in text content in a media file to be played acceleratedly.

The media file determination module 1302 is configured to determine a media file corresponding to the key content acquired by the key content acquisition module 1301.

The media file playback module 1303 is configured to play the media file determined by the media file determination module 1302.

Alternatively, the key content acquisition module 1301, the media file determination module 1302, and the media file playback module 1303 may be all provided in a single device, e.g., a cloud server, a smart phone or a smart watch, etc.

Alternatively, the key content acquisition module 1301, the media file determination module 1302, and the media file playback module 1303 may be provided in different devices that perform data transmission with each other.

Compared with the data transmission, the speech recognition, the content simplification, and the audio/video processing require higher power consumption, so different operation strategies may be employed with regard to different conditions when the electric quantity of one or more intelligent devices participating in the fast playback and browsing operation is insufficient.

In the examples below, as shown in Table 5.1, Table 5.2, Table 5.3 and Table 5.4, all related processing required for fast playback/browsing is completed in a single device.

TABLE 5.1

| | Device | Electric | |
|---|---|---|---|
| Cases | type | quantity | Implementation operation |
| 1.1 | Cloud | — | Transmit full content to a smart phone |
| | server | | |
| | Smart | High | Complete speech recognition, content |
| | phone | | simplification and audio/video processing |
| | Smart | High | Control and trigger operations |
| | watch | | |
| 1.2 | Cloud | — | Transmit full content to a smart phone |
| | server | | |
| | Smart | High | Transmit full content to a smart watch |
| | phone | | |
| | Smart | High | Complete speech recognition, content |
| | watch | | simplification and audio/video processing |
| | | | Control and trigger operations |
| 1.3 | Cloud | — | Transmit the simplified content to a |
| | server | | smart phone |
| | Smart | High | Transmit the simplified content to a |
| | phone | | smart watch |
| | Smart | High | Control and trigger operations |
| | watch | | |

TABLE 5.2

| | Device | Electric | |
|---|---|---|---|
| Cases | type | quantity | Implementation operation |
| 2.1 | Cloud | — | Transmit full content to a |
| | server | | smart phone |
| | Smart | High | Complete speech recognition, |
| | phone | | content simplification and |
| | | | audio/video processing |
| | Smart | Low | Control and trigger operations |
| | watch | | |
| 2.2 | Cloud | — | Transmit the simplified content |
| | server | | to a smart phone |
| | Smart | High | Transmit the simplified content |
| | phone | | to a smart watch |
| | Smart | Low | Control and trigger operations |
| | watch | | |

TABLE 5.3

| | Device | Electric | |
|---|---|---|---|
| Cases | type | quantity | Implementation operation |
| 3.1 | Cloud | — | Transmit full content to a |
| | server | | smart phone |
| | Smart | Low | Transmit full content to a |
| | phone | | smart watch |
| | Smart | High | Complete speech recognition, |
| | watch | | content simplification and |
| | | | audio/video processing |
| | | | Control and trigger operations |
| 3.2 | Cloud | — | Transmit the simplified content |
| | server | | to a smart phone |
| | Smart | Low | Transmit the simplified content |
| | phone | | to a smart watch |
| | Smart | High | Control and trigger operations |
| | watch | | |

TABLE 5.4

| | Device | Electric | |
|---|---|---|---|
| Cases | type | quantity | Implementation operation |
| 4.1 | Cloud | — | Transmit the simplified |
| | server | | content to a smart phone |
| | Smart | Low | Transmit the simplified |
| | phone | | content to a smart watch |
| | Smart | Low | Control and trigger |
| | watch | | operations |

In the examples below, as shown in Table 6.1, Table 6.2, Table 6.3, and Table 6.4, the related processing required for fast playback or browsing is distributed over different devices.

TABLE 6.1

| | Device | Electric | |
|---|---|---|---|
| Cases | type | quantity | Implementation operation |
| 1.1 | Cloud | — | Transmit full content to a smart |
| | server | | phone |
| | Smart | High | Complete speech recognition and |
| | phone | | content simplification |
| | Smart | High | Complete audio/video processing, |
| | watch | | and control and trigger operations |
| 1.2 | Cloud | — | Transmit full content to a smart |
| | server | | phone |
| | Smart | High | Complete speech recognition |
| | phone | | |
| | Smart | High | Complete content simplification |
| | watch | | and audio/video processing, and |
| | | | control and trigger operations |
| 1.3 | Cloud | — | Transmit the simplified content to |
| | server | | a smart phone |
| | Smart | High | Transmit the simplified content to |
| | phone | | a smart watch |
| | Smart | High | Control and trigger operations |
| | watch | | |

TABLE 6.2

| | Equipment | Electric | |
|---|---|---|---|
| Cases | type | quantity | Implementation operation |
| 2.1 | Cloud | — | Transmit full content to a smart |
| | server | | phone |
| | Smart | High | Complete speech recognition |
| | phone | | and content simplification |
| | Smart | Low | Complete audio/video processing, |
| | watch | | and control and trigger operations |
| 2.2 | Cloud | — | Transmit the simplified content to |
| | server | | a smart phone |
| | Smart | High | Transmit the simplified content to |
| | phone | | a smart watch |
| | Smart | Low | Control and trigger operations |
| | watch | | |

TABLE 6.3

| | Device | Electric | |
|---|---|---|---|
| Cases | type | quantify | Implementation operation |
| 3.1 | Cloud | — | Transmit full content to a smart |
| | server | | phone |
| | Smart | Low | Complete speech recognition |
| | phone | | |
| | Smart | High | Complete content simplification |
| | watch | | and audio/video processing |
| | | | Control and trigger operations |
| 3.2 | Cloud | — | Transmit the simplified content |
| | server | | to a smart phone |
| | Smart | Low | Transmit the simplified content |
| | phone | | to a smart watch |
| | Smart | High | Control and trigger operations |
| | watch | | |

TABLE 6.4

| | Device | Electric | |
|---|---|---|---|
| Cases | type | quantity | Implementation operation |
| 4.1 | Cloud | — | Transmit the simplified |
| | server | | content to a smart phone |
| | Smart | Low | Transmit the simplified |
| | phone | | content to a smart watch |
| | Smart | Low | Control and trigger |
| | watch | | operations |

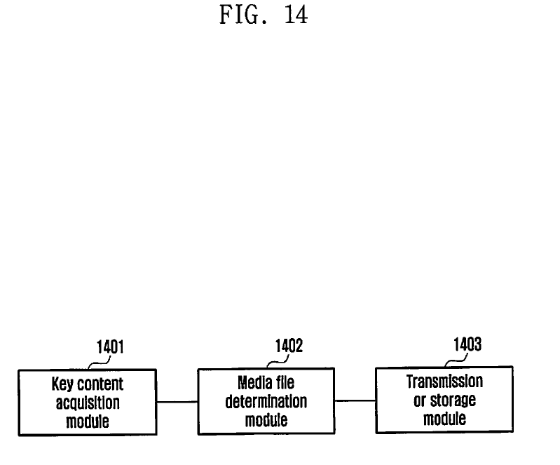

FIG. 14 illustrates a device for compressing and storing a media file according to an embodiment of the present disclosure.

Referring to FIG. 14, the device includes a key content acquisition module 1401, a media file determination module 1402, and a transmission or storage module 1403.

The key content acquisition module 1401 is configured to acquire key content in text content of a media file to be transmitted or stored, if preset compression conditions are met while transmitting or storing the media file.

The media file determination module 1402 is configured to determine a media file corresponding to the key content acquired by the key content acquisition module 1401.

The transmission or storage module 1403 is configured to transmit or store the media file determined by the media file determination module 1402.

As described above, for a media file to be processed (e.g., an audio file, a video file, an electronic text filed, etc.), the text content of the media file is simplified to acquire key content in the text content of the media file; and the determined media file is played or transmitted after a media file corresponding to the acquired key content is determined. As the played or transmitted content is reduced with respect to the original media file, the accelerated playback or compressed transmission of the media file may be performed. In comparison with providing the conventional accelerated playback of a media file by compressing the playback time, by simplifying text content of a media file, the present disclosure reserves the key content of the original text content and ensures the integrity of information, so that a user can acquire key information in the media file even if the playback speed is very fast.

The above-described embodiments of the present disclosure may be applied in the accelerated playback of a media file in local or from a sever, and may also provide compressed transmission and storage of the media file according to actual needs, thereby reducing the requirements on the network environment and the storage space by transmission.

The above-described embodiments of the present disclosure may also be applied in the playback of audio/video in local or from a server, and provide simplified audio/video transmission content as required, thereby reducing the requirements of transmission on the network environment.

A person of ordinary skill in the art will appreciate that the present disclosure includes devices for performing one or more of operations as described above. Those devices may be specially designed and manufactured as intended, or can include well known devices in a general-purpose computer. Those devices have computer programs stored therein, which are selectively activated or reconstructed. Such computer programs can be stored in device (such as computer) readable media or in any type of media suitable for storing electronic instructions and respectively coupled to a bus, the computer readable media include but are not limited to any type of disks (including floppy disks, hard disks, optical disks, compact disc-read-only memory (CD-ROM) and magneto optical disks), ROM, random access memory (RAM), erasable programmable ROM (EPROM_, Electrically EPROM (EEPROM), flash memories, magnetic cards or optical line cards. That is, readable media include any media storing or transmitting information in a device (for example, computer) readable form.

A person of ordinary skill in the art will appreciate that computer program instructions may be used to realize each block in structure diagrams and/or block diagrams and/or flowcharts as well as a combination of blocks in the structure diagrams and/or block diagrams and/or flowcharts. A person of ordinary skill in the art will appreciate that these computer program instructions can be provided to general purpose computers, special purpose computers or other processors of programmable data processing means to be implemented, so that solutions designated in a block or blocks of the structure diagrams and/or block diagrams and/or flow diagrams are executed by computers or other processors of programmable data processing means.

A person of ordinary skill in the art will appreciate that the steps, measures and solutions in the operations, methods and flows already discussed in the present disclosure may be alternated, changed, combined or deleted. Further, other steps, measures and solutions in the operations, methods and flows already discussed in the present disclosure can also be alternated, changed, rearranged, decomposed, combined or deleted. Further, the steps, measures and solutions of the prior art in the operations, methods and operations disclosed in the present disclosure can also be alternated, changed, rearranged, decomposed, combined or deleted.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. A method for accelerated playback of a media file, the method comprising:
acquiring key content in text content of a media file to be played acceleratedly;
determining a media file corresponding to the key content; and
playing the determined media file.

2. The method of claim 1, wherein the key content in the text content of the media file to be played acceleratedly is acquired according to at least one of:
a part-of-speech of content units in the text content;
an amount of information of the content units;
an audio volume of the content units;
an audio speech speed of the content units;
content of interest in the text content;
a media file type;
information about content source objects;
an acceleration rate;
a media file quality; and
a playback environment.

3. The method of claim 2, wherein acquiring the key content in the text content in the media file to be played acceleratedly according to the part-of-speech of the content units in the text content corresponding to the media file to be played acceleratedly comprises at least one of:
determining, in the text content of at least two content units, content units corresponding to an auxiliary part-of-speech not to be the key content;
determining, in the text content including at least two content units, content units corresponding to a key part-of-speech to be the key content;
determining content units of a specified part-of-speech not to be the key content; and
determining content units of the specified part-of-speech to be the key content.

4. The method of claim 3, wherein the auxiliary part-of-speech includes a part-of-speech including at least one of a modification function, an auxiliary description function, and a determination function.

5. The method of claim 2, wherein acquiring the key content in the text content in the media file to be played acceleratedly according to the audio volume of the content units in the text content comprises determining, according to the audio volume of a content unit included in the text content corresponding to the media file to be played acceleratedly, whether the content unit is key content.

6. The method of claim 2, wherein acquiring the key content in the text content in the media file to be played acceleratedly according to the audio speech speed of the content units in the text content comprises determining, according to the audio speech speed of a content unit included in the text content corresponding to the media file to be played acceleratedly, whether the content unit is key content.

7. The method of claim 2, wherein acquiring the key content in the text content of the media file to be played acceleratedly according to the content of interest in the text content comprises at least one of:
determining corresponding matched content to be the key content, if there is content of interest in a preset lexicon of interest matched in the text content;
classifying a content unit by a preset classifier of interest, and determining the classified content unit to be the key content, if the result of classification is content of interest;
determining corresponding matched content not to be the key content, if there is content out of interest in a preset lexicon of disinterest matched in the text content; and
classifying a content unit by a preset classifier of disinterest, and determining the content unit not to be the key content, if the result of classification is content of disinterest.

8. The method of claim 2, wherein acquiring the key content in the text content of the media file to be played acceleratedly according to the media file type comprises determining content, which is matched with keywords corresponding to the media file type to which the content belongs, in the text content, to be the key content.

9. The method of claim 2, wherein acquiring the key content in the text content of the media file to be played acceleratedly according to the acceleration rate comprises determining, according to key content in the text content of the media file determined at a previous acceleration rate, the key content in the text content of the media file to be played acceleratedly at a current acceleration rate.

10. The method of claim 2, wherein acquiring the key content in the text content of the media file to be played acceleratedly comprises:
selecting, according to at least one of the acceleration rate, the media file quality, and the playback environment, the information on which the acquisition of the key content is based from the part-of-speech of content units in the text content, the amount of information of the content units, the audio volume of the content units, the audio speech speed of the content units, content of interest in the text content, the media file type, and information about content source objects; and
acquiring the key content in the text content of the media file to be played acceleratedly according to the selected information.

11. The method of claim 2, further comprising:
determining a granularity of partition of the content units in the text content according to the acceleration rate corresponding to the media file to be played acceleratedly; and
partitioning the content units of the text content according to the determined granularity of partition.

12. The method of claim 1, wherein determining the media file corresponding to the key content comprises:
determining information about a time and a position corresponding to each content unit in the key content;
extracting corresponding media file fragments according to the information about the time and the position; and
generating the media file by combining the extracted media file fragments.

13. The method of claim 1, wherein playing the determined media file comprises:
performing quality enhancement on the determined media file based on the media file quality; and
playing the quality-enhanced media file.

14. The method of claim 1, wherein playing the determined media file comprises:
determining at least one of a playback speed and a playback volume based on at least one of an audio speech speed, an audio volume, a content importance, a media file quality, and a playback environment; and
playing the determined media file at the determined at least one of the playback speed and the playback volume.

15. The method of claim 1, wherein the media file comprises at least one of:
an audio file;
a video file; and
an electronic text file.

16. The method of claim 15, wherein when the media file comprises the video file, acquiring the key content in the text content of the media file to be played acceleratedly comprises at least one of:
determining the key content of audio content of the video file according to the audio content and image content of the video file;
determining the key content of the image content of the video file according to the audio content and the image content of the video file;
determining the key content corresponding to the video file according to at least one of a video file type, the audio content of the video file, and the image content of the video content; and
determining the key content corresponding to the video file according to at least one of the type of audio content and the type of image content of the video file.

17. The method of claim 16, wherein playing the determined media file comprises at least one of:
extracting, in the image content of the video file, image content corresponding to the key content of the audio content according to a correspondence between the audio content and the image content, and synchronously playing audio frames corresponding to the key content of the audio content and image frames corresponding to the extracted image content;
playing audio frames corresponding to the key content of the audio content, and playing image frames of the video file at an acceleration rate; and
playing the audio frames corresponding to the key content of the audio content and image frames corresponding to the key content of the image content.

18. A method for transmitting and storing a media file, the method comprising:
acquiring key content in text content of a media file to be transmitted or stored, if a preset compression condition is met;
determining a media file corresponding to the key content; and
transmitting or storing the determined media file.

19. A device for accelerated playback of a media file, the device comprising:
a key content acquisition module configured to acquire key content in text content in a media file to be played acceleratedly;
a media file determination module configured to determine a media file corresponding to the key content; and
a media file playback module configured to play the determined media file.

20. A device for transmitting and storing a media file, the device comprising
a key content acquisition module configured to acquire key content in text content of a media file to be transmitted or stored, if a preset compression condition is met;
a media file determination module configured to determine a media file corresponding to the key content; and
a transmission or storage module configured to transmit or store the determined media file.
